(19) United States
(12) Patent Application Publication
(10) Pub. No.: US 2024/0403609 A1
(43) Pub. Date: Dec. 5, 2024

(54) VIRTUAL SENSOR MODULE FOR COMPUTING SPATIAL-TEMPORAL TEMPERATURE MEASUREMENTS OF A BATTERY

(71) Applicants: Nanyang Technological University, Singapore (SG); Durapower Holdings Pte. Ltd., Singapore (SG)

(72) Inventors: Hung Dinh NGUYEN, Singapore (SG); Jiahang XIE, Singapore (SG); Rufan YANG, Singapore (SG); Hoay Beng GOOI, Singapore (SG); Hock Seng Kelvin LIM, Singapore (SG); Donghan SHI, Singapore (SG)

(73) Assignees: Nanyang Technological University, Singapore (SG); Durapower Holdings Pte. Ltd., Singapore (SG)

(21) Appl. No.: 18/528,028

(22) Filed: Dec. 4, 2023

(30) Foreign Application Priority Data
Jun. 5, 2023 (SG) 10202301568X

(51) Int. Cl. G06N 3/0455; G06N 3/0985; H01M 10/48

(52) U.S. Cl. CPC G06N 3/0455; G06N 3/0985; H01M 10/486

(57) ABSTRACT

This document describes a virtual sensor module for generating spatial-temporal temperature measurements of a battery and a method of using the virtual sensor module to generate the above-mentioned measurements. The virtual sensor module utilizes a Proportional-Integral-Derivative (PID) controller module communicatively coupled to a trained convolutional neural network—long-short-term memory (CNN-LSTM) module to trigger the trained CNN-LSTM module to generate a refined predicted series of real temperature sequences across the battery, based on a set of optimized PID parameters (K*ₚ, K*ᵢ, K*_{d}), predicted error sequences, and measured temperature sequences of the battery.

### CROSS-REFERENCE TO RELATED APPLICATION

This application claims the benefit of priority to Singapore patent application no. 10202301568X which was filed on 5 Jun. 2023, the contents of which are hereby incorporated by reference in its entirety for all purposes.

### TECHNICAL FIELD

This application relates to a virtual sensor module for computing spatial-temporal temperature measurements of a battery and a method that uses the virtual sensor module in the generation of the spatial-temporal temperature measurements of the battery.

### BACKGROUND

Energy storage systems (ESS) are gaining importance in smart grid and electric vehicle (EV) operations, especially in view of their ability to improve the exploitation of intermittent and uncertain renewable energy sources. Battery energy storage systems (BESS) are prevalent among various kinds of ESS, thanks to their high energy efficiency, reusability, and convenience in intelligent management deployments. However, current BESSs are suffering from severe operational safety risks and there are several factors causing this trend.

The aggressive introduction of complex loads such as EVs onto existing power networks necessitates the integration of battery energy storage systems to fill the gap in the supply of power in existing networks. A large number of second-life batteries have been deployed in ESS for sustainable operations therefore, these aging battery system infrastructures and equipment also pose additional risks as they may lead to more frequent temperature spikes and thermal runaways if proper maintenance is not regularly carried out and if proper regulations are not in place. Such operating conditions would eventually result in catastrophic damage to existing systems. In the past, a number of major fire disasters of BESSs have caused great economic losses and casualties. Therefore, timely, accurate and intelligent monitoring of battery temperatures is crucial in reducing fire hazards caused by BESS. Presently, comprehensive monitoring and estimation of BESS thermal conditions have generally been limited by the number, measuring range, and precision of thermal sensors as well as the large amount of measured data in practical day to day operations.

To address the issues mentioned above, virtual sensors have been proposed as physically and economically viable alternatives. Virtual sensors utilize compressed sensing techniques to mimic physical systems, addressing the challenges posed by practical limitations in physical sensors, such as their measurement area, range, and accuracy. This simulation facilitates the detection, recognition, and completion of data gaps in the physical sensor readings. The sensing techniques utilized by virtual sensors first receives descriptions of measurable physical quantities, subsequently simulates the physical process based on the properties of the real system and finally compensates for missing information that cannot be measured in the sensor device.

There are several existing techniques for virtually estimating the surface temperature distribution of batteries based on sensor measurements, but most of them do not address the issue of limited measurement points of physical sensors and additionally, are not highly accurate. The most common approach is to use a simple physical model and iteratively substitute measured parameters into the equations of the model. By gradually fitting the model, the model is then configured to monitor the temperature of the battery. However, simple linear models have low accuracy due to improper settings, large time steps and data outliers. More often than not, battery surface temperature distributions are not measured by the model. Instead, the model will only measure average or maximum temperature values and this is done using a limited number of physical sensors that are provided on the battery. Such models will also not be able to capture the nonlinear nature of battery temperature variations. Despite efforts of those skilled in the art to improve the accuracy of virtual sensors used in battery energy storage systems, the current techniques still possess several constraints, such as being computationally intensive, overly physically complex, and inaccurate.

### SUMMARY

In one aspect, the present application discloses a virtual sensor module for computing spatial-temporal temperature measurements of a battery. The disclosed module comprises a Proportional-Integral-Derivative (PID) controller module communicatively coupled to a trained convolutional neural network—long-short-term memory (CNN-LSTM) module. The PID controller module is configured to trigger the CNN-LSTM module to generate refined predicted real temperature sequences Tₜ^{p} across the battery based on a set of optimized PID parameters (K*ₚ, K*ᵢ, K*_{d}), predicted error sequences eₜ^{p}, and measured temperature sequences Tₜ^{m} of the battery. The CNN-LSTM module triggered by the PID controller module was previously trained based on a training set of spatial-temporal temperature measurements of the battery, and whereby the optimized PID parameters were generated based on a training set of measured temperature sequences and a series of known output temperature sequences.

In another aspect, the present application discloses a method for computing spatial-temporal temperature measurements of a battery using a virtual sensor module. The disclosed method includes the step of triggering, using a Proportional-Integral-Derivative (PID) controller module communicatively coupled to a trained convolutional neural network—long-short-term memory (CNN-LSTM) module the CNN-LSTM module to generate refined predicted series of real temperature sequences Tₜ^{p} across the battery based on a set of optimized PID parameters (K*ₚ, K*ᵢ, K*_{d}), predicted error sequences eₜ^{p}, and a series of measured temperature sequences Tₜ^{m} of the battery. The CNN-LSTM module triggered by the PID controller module was previously trained based on a training set of spatial-temporal temperature measurements of the battery, and whereby the optimized PID parameters were generated based on a training set of measured temperature sequences and a series of known output temperature sequences.

### BRIEF DESCRIPTION OF THE DRAWINGS

Various embodiments of the present disclosure are described below with reference to the following drawings:

FIG. 1 illustrates a block diagram of a virtual sensor for computing spatial-temporal temperature measurements of a battery based on optimized Proportional-Integral-Derivative (PID) parameters, predicted error sequences and a series of measured temperature sequences of the battery in accordance with embodiments of the present disclosure;

FIG. 2 illustrates a block diagram of a virtual sensor for generating the optimized PID parameters and the predicted error sequences based on a series of measured temperature sequences of the battery and a series of known output temperature sequences in accordance with embodiments of the present disclosure;

FIG. 3 illustrates a network architecture of a convolutional neural network—long short term memory (CNN-LSTM) in accordance with embodiments of the present disclosure;

FIG. 4 illustrates a timing diagram that illustrates time concepts and notations used in embodiments of the present disclosure;

FIG. 5 illustrates a timing diagram showing transfers of internal states of a Proportional-Integral-Derivative controller integrated with a CNN-LSTM module for prediction of time series sequences in accordance with embodiments of the present disclosure;

FIG. 6A illustrates a three-dimensional (3D) structure of a pouch battery in accordance with embodiments of the present disclosure;

FIG. 6B illustrates a thermal resistance model of the pouch battery illustrated in FIG. 6A in accordance with embodiments of the present disclosure;

FIG. 7 illustrates plots of a CNN-LSTM step response, a step response of an approximated first-order system and a step response of an approximated first-order system with PID control in accordance with embodiments of the present disclosure;

FIG. 8A illustrates a system root locus plot for a first term in the system transfer function;

FIG. 8B illustrates a system root locus plot for a second term in the system transfer function;

FIG. 9 illustrates a block diagram representative of a processing system for performing embodiments of the present disclosure;

FIG. 10 illustrates a flowchart of a method for computing spatial-temporal temperature measurements of a battery based on optimized PID parameters, predicted error sequences and a series of measured temperature sequences of the battery in accordance with an embodiment of the present disclosure;

FIG. 11A illustrates an example of temperature distribution data under a constant volumetric heat source qi for a sampling interval of 10 seconds;

FIG. 11B illustrates an example of temperature distribution data under a constant volumetric heat source \dot{q}₂ for a sampling interval of 10 seconds;

FIG. 11C illustrates an example of temperature distribution across the battery when the battery charging C-rate is 1C;

FIG. 11D illustrates an example of temperature distribution across the battery when the battery charging C-rate is 3C;

FIG. 12 illustrates a box plot showing the temperature information for various charging scenarios;

FIG. 13A illustrates training and validation loss plots based on a simulation setup and hyper-parameters for scenario 1;

FIG. 13B illustrates training and validation loss plots based on a simulation setup and hyper-parameters for scenario 3;

FIG. 14A illustrates real and final prediction plots for scenario 1 and 2 which are based on one-dimensional data;

FIG. 14B illustrates real and final prediction temperature distributions across the battery for scenarios 3, 4 and 5 which are based on two-dimensional data;

FIG. 15A illustrates plots of the mean absolute error (MAE) of PID error with target sequences and the predicted error for scenario 1;

FIG. 15B illustrates plots of the MAE of PID error with target sequences and the predicted error for scenario 5;

FIG. 16A illustrates plots showing the evolution of temperature distribution for scenario 1;

FIG. 16B illustrates plots showing the evolution of temperature distribution for scenario 5;

FIG. 17A illustrates plots showing temperature distribution across the battery at the final time step for scenario 1;

FIG. 17B illustrates a histogram showing the MAE along the x-axis of the battery at the final time step;

FIG. 18A illustrates thermal images of predicted temperature distributions across the battery at the final time step;

FIG. 18B illustrates three-dimensional plots showing the predicted temperature distributions across the battery at the final time step for scenario 5;

FIG. 18C illustrates three-dimensional plots showing the element-wise absolute error at the final time step for scenario 5; and

FIG. 18D illustrates MAE plots along the y-axis of the battery at the final time step for scenario 5.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

As used herein, to make notations clear, bold symbols are used to denote sequences, and a sequence is defined herein as an enumerated collection of elements or terms in which repetitions are allowed and the elements or terms are in a particular order.

Further, one skilled in the art will recognize that certain functional units in this description have been labelled as modules throughout the specification. The person skilled in the art will also recognize that a module may be implemented as circuits, logic chips or any sort of discrete component. Still further, one skilled in the art will also recognize that a module may be implemented in software which may then be executed by a variety of processor architectures. In embodiments of the disclosure, a module may also comprise computer instructions or executable code that may instruct a computer processor to carry out a sequence of events based on instructions received. The choice of the implementation of the modules is left as a design choice to a person skilled in the art and does not limit the scope of the claimed subject matter in any way.

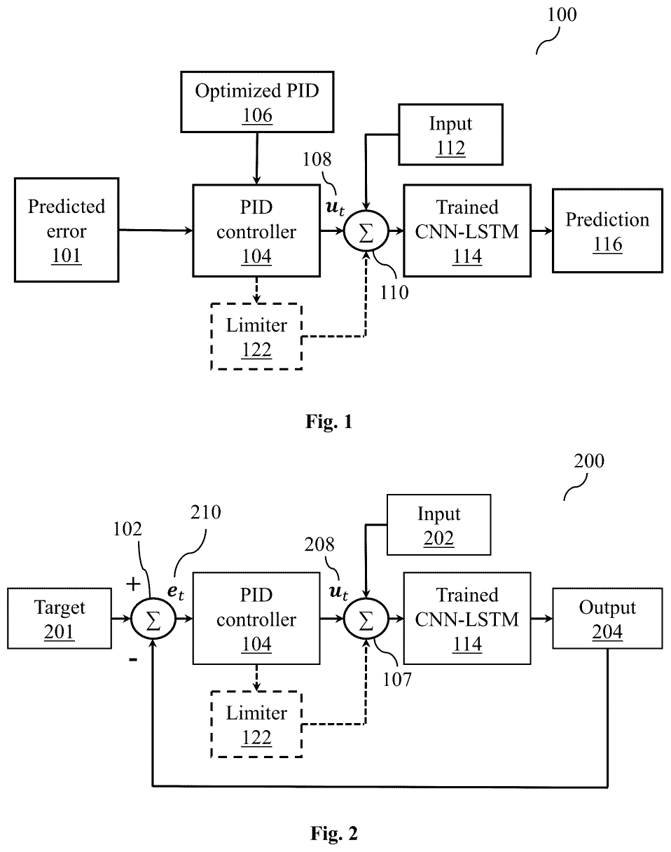

A block diagram of a virtual sensor for computing spatial-temporal temperature measurements of a battery based on optimized Proportional-Integral-Derivative (PID) parameters, predicted error sequences and a series of measured temperature sequences of the battery in accordance with an embodiment of the present disclosure is illustrated in FIG. 1. As illustrated, virtual sensor 100 comprises Proportional-Integral-Derivative (PID) controller module 104 that is communicatively coupled to trained convolutional neural network—long-short-term memory (CNN-LSTM) module 114. PID controller module 104 is configured to trigger CNN-LSTM module 114 to generate refined predicted real temperature sequences Tₜ^{p} 116 across a battery based on a set of optimized PID parameters (K*ₚ, K*ᵢ, K*_{d}) 106, predicted error sequences eₜ^{p} 101, and measured temperature sequences Tₜ^{m} 112 of the battery. It should be noted that the CNN-LSTM module was trained based on a training set of spatial-temporal temperature measurements of the battery. Additionally, the optimized PID parameters were obtained based on a training set of measured temperature sequences and a series of known output temperature sequences. The training of the CNN-LSTM module, and the generation of the optimized PID parameters and predicted error sequences will be described in greater detail in the later sections of this description.

In embodiments of the present disclosure, PID controller module 104 comprises a classic PID controller that is configured to exploit the past, present, and future information of prediction errors to control a feedback system. A classic PID controller is configured to continuously calculate the difference e(t) between the desired output and the measured system output and applies a correction u(t) to the system based on the proportional (P), integral (I), and derivative (D) terms of e(t). The correction signal may be defined as:

$$u ( t ) = {K}_{p} e ( t ) + {K}_{i} {\int }_{0}^{t} e ( t ) d t + {K}_{d} \frac{d}{dt} e ( t ) \qquad ( 1 )$$

where Kₚ, Kᵢ, K_{d} are the P, I, D coefficients respectively. These coefficients determine the contributions of the present, past and future errors to the current correction. Within a reasonable range, the proportional gain can accelerate the control process while the integral gain can minimize the steady-state tracking error and the steady-state output response to disturbances. The derivative feedback can improve closed-loop system stability as well as speed up the transient response and reduce overshoot. The detailed workings of a classic PID controller are omitted for brevity as it is known to one skilled in the art.

In embodiments of the present disclosure, trained CNN-LSTM module 114 is configured to simulate characteristics of BESS internal temperature distribution time sequence data after it has been trained based on a training set of spatial-temporal temperature measurements of the battery. The CNN-LSTM architecture of the trained CNN-LSTM module was selected as it was able to identify battery temperature distribution dynamics based on plane inputs. By combining convolutional neural network (CNN) layers with LSTM blocks, the network is both spatially and temporally deep and has the flexibility to handle datasets with sequential inputs and outputs.

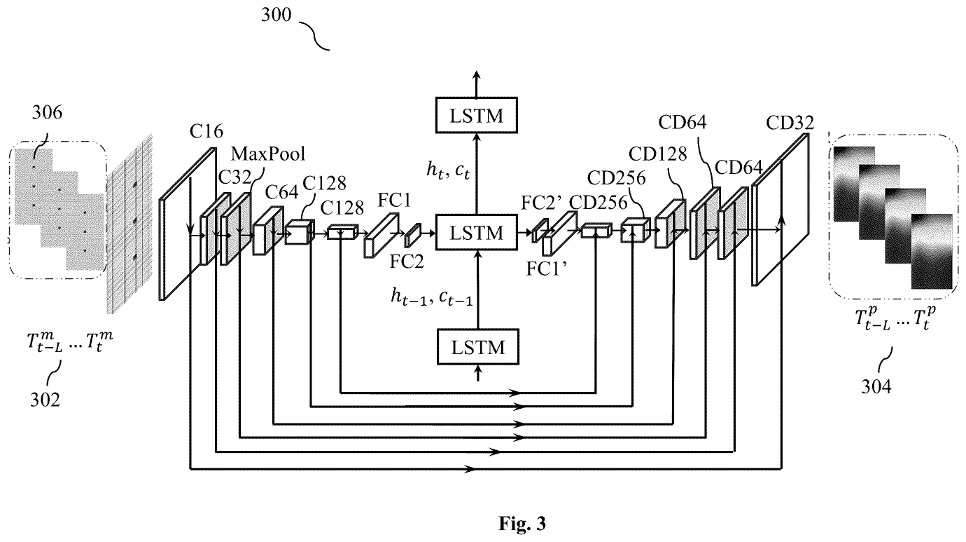

In embodiments of the present disclosure, the network structure of trained CNN-LSTM module 114 is illustrated in FIG. 3. As shown, network structure 300 comprises an end-to-end trainable model, i.e., the prediction is made based on raw input sequence 302 to produce output sequence 304. In particular, sequence input points 306 representing sensor measurements of thermal monitoring points on a battery pouch cell surface are fed into the CNN-LSTM model and the corresponding output is the full temperature distribution with respect to each input measurement for supervised learning. The encoder-decoder prototype is exploited to extract spatial information within the temperature distribution. Intermediate convolutional layer outputs are scaled features at the corresponding time step, encoded as vectors in the latent space to be used as inputs for the LSTM blocks. One-dimensional sequences then pass through the corresponding LSTM blocks, where internal states h, c are propagated sequentially. Finally, the decoder structure performs transposed convolution to recover the output size data.

In embodiments of the disclosure, the layer composition of the CNN-LSTM model may be defined as follows: ‘Ck’ represents a Convolution-BatchNorm-ReLU layer with k filters, ‘CDk’ represents a Convolution-BatchNormDropout-ReLU layer with a dropout rate of 50%, where all convolutions comprise 4×4 spatial filters with stride 2. ‘FCk’ represents the k-th FullyConnected-LeakyReLU layer with slope 0.2 and ‘MaxPool’ applies a two-dimensional max pooling to a previous layer's output with 4×4 spatial filters, stride 1 and padding size 1. The number of hidden state features in the LSTM block is set as 128 and convolutions in the encoder are down sampled by a factor of 2, whereas in the decoder they up-sampled by a factor of 2. To enhance CNN-LSTM performance, the “U-Net” structure is incorporated into the overall design, skip connections are added to the network, generally in the form of a “U-Net”, to provide a mechanism for it to circumvent the bottleneck. More precisely, skip connections are added between each layer i in the encoder and layer n−i in the decoder, where n denotes the total number of layers. Each skip then concatenate joins the channels from layers i and n−i together. Hence, the encoder-decoder architecture may be defined as:
encoder:
C16-C32-MaxPool(32)-C64-C128-C128-FC1-FC2-LSTM
decoder (U-Net):
FC2′-FC1′-CD256-CD256-CD128-CD64-CD64-CD32

After the last layer in the decoder, a transposed convolution is applied to map the output channels with a Tanh activation function. As an exception in the above notations, BatchNorm is not applied to the first C16 layer in the encoder. All ReLUs in the encoder are leaky, with slope 0.2, whereas the ones in the decoder are not leaky. The trained CNN-LSTM model may then be used to identify the dynamics in temperature variation data.

Returning to FIG. 1, optimized PID parameters 106 and predicted error 101 may both be generated by PID controller module 104 and trained CNN-LSTM module 114 when these two modules are operated in an “optimized PID parameters and predicted error sequences generation” mode or for simplicity, in “offline” mode. The block diagram showing the operation of modules 104 and 114 in “offline” mode 200 is illustrated in FIG. 2.

With reference to FIG. 2, when PID controller module 104 and trained CNN-LSTM module 114 are operating in “offline” mode 200, optimized PID parameters 106 are obtained by tuning PID controller 104 and trained CNN-LSTM module 114 based on known reference values or known target output temperature sequences 201 and a training set of measured time sequences of the battery 202. In embodiments of the disclosure, the training set of measured time sequences of the battery may be obtained from thermal monitoring points on the battery pouch cell surface and the known target output temperature sequences may be obtained through the more detailed computational fluid dynamic (CFD) modeling of the temperature distribution across the battery. As such, known target output temperature sequence Tₜ^{r} 201 at time t may be defined as:

$${T}_{t}^{r} {:= [ {T}_{t - ℒ}^{r} , … , {T}_{t - 1}^{r} , {T}_{t}^{r} ]}^{T} , {T}_{t}^{r} ∈ {ℝ}^{r \times c} \qquad ( 2 )$$

and a measured time sequence Tₜ^{m} 202 of the battery at time t as obtained from the training set of measured time sequences may be defined as:

$${T}_{t}^{m} {:= [ {T}_{t - ℒ}^{m} , … , {T}_{t - 1}^{m} , {T}_{t}^{m} ]}^{T} , {T}_{t}^{m} ∈ {ℝ}^{r \times c} \qquad ( 3 )$$

where [symbol] represents the input sequence length, and r, c represents the size of the temperature distribution plane.

In embodiments of the present disclosure, the relationship between the measured time sequences Tₜ^{m} 202 and the known target output temperature sequence Tₜ^{r} 201 at time t may be defined as:

$${T}_{t}^{m} = V {T}_{t}^{r} + ξ \qquad ( 4 )$$

where [symbol] is the linear measuring transform and ξ is the noise induced from sensor and other hardware devices. When a machine learning approach is adopted, the objective is to approximate [symbol] so that the differences between predictions and the real actual values are minimized.

When measured temperature sequence Tₜ^{m} 202 of the battery at time t is provided as input to the trained CNN-LSTM module 114, the reconstructed temperature distribution sequence computed by trained CNN-LSTM module 114, or output Oₜ 204 of trained CNN-LSTM module 114 at time t may be obtained as:

$${O}_{t} {:= [ {T}_{t - ℒ}^{p} , … , {T}_{t - 1}^{p} , {T}_{t}^{p} ]}^{T} = \hat{V} ( {T}_{t}^{m} \vert {O}_{t - ℒ} ) , {T}_{t}^{p} ∈ {ℝ}^{r \times c} \qquad ( 5 )$$

where [symbol] is the approximation of the reversed measuring process for data sequences and is [symbol] dependent on previous time prediction and [symbol] establishes the identified dynamical temperature variation system (and this notation [symbol] is used to represent the CNN-LSTM neural network). [symbol] represents the input sequence length, and r, c represents the size of the temperature distribution plane.

Hence, an error 210 between known target output temperature sequence Tₜ^{r} 201 at time t and output Oₜ 204 of trained CNN-LSTM module 114 at time t may be computed by obtaining the difference of these values at module 102. The error eₜ 210 may be defined as:

$${e}_{t} = {T}_{t}^{r} - {O}_{t} \qquad ( 6 )$$

The computed error 210 is then fed back into PID controller module 104 to obtain control signal uₜ 208 in a discretized time domain. The control signal uₜ may be defined as:

$${u}_{t} = {K}_{p} {e}_{t} + {K}_{i} {\sum }_{i = 0}^{t} {e}_{i} + {K}_{d} ( {e}_{t} - {e}_{t - 1} ) \qquad ( 7 )$$

where Kₚ, Kᵢ, K_{d} are the P, I, D coefficients respectively as mentioned in the sections above.

The control signal uₜ 208 may then be added as the correction to the next measured temperature sequence [symbol] at module 107 to form uₜ+ [symbol] as the updated input for the next time step. The combination of uₜ+ [symbol] is then provided as the input for trained CNN-LSTM module 114 to update the CNN-LSTM's internal states. The iteration process propagates along the timeline until the expected response step s is reached, i.e., total time steps is s [symbol] , and produces the predicted results at the expected time point.

In embodiments of the disclosure, as shown in FIGS. 1 and 2, a limiter module 122 may be provided at the output of PID controller 104 to regulate the control signal uₜ before the control signal uₜ is provided to module 110 in FIG. 1 or module 107 in FIG. 2.

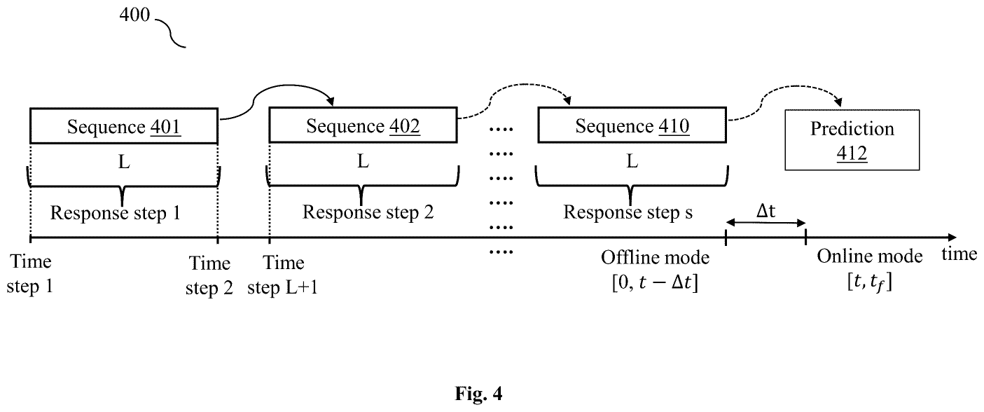

It is noteworthy that in this description, “time step” refers to the actual time point t−1, t, t+1, . . . and “response step” refers to the number of PID action steps or the number of time steps within one PID control process, wherein each response step corresponds to the last time step of each sequence. The “time” concepts used in this description are illustrated in FIG. 4 with timing diagram 400.

As shown in FIG. 4, at time step 1, sequence 401, which comprises a combination of the control signal and the next measured temperature sequence, is provided to trained CNN-LSTM module 114, and the processing of sequence 401 by trained CNN-LSTM module 114 ends at time step 2. Subsequently, at time step [symbol] +1, sequence 402, which comprises a combination of another control signal and the next measured temperature sequence, is provided to trained CNN-LSTM module 114, and this process continues until the expected response step s is reached, i.e., total time steps is s [symbol] has lapsed, with sequence 410 being the last sequence that was processed.

The time interval of the “offline” mode may be set as [0, t−Δt], Δt>0, in which the range [t−2Δt, t−Δt] was selected as the PID adjustment samples (i.e., the data samples used to obtain the PID parameters). Once the optimized PID parameters and the predicted error sequences have been obtained, PID controller 104 and trained CNN-LSTM module 114 may use these parameters together with the latest measured temperature sequences to generate refined predicted real temperature sequences 412. For illustration purposes, in timing diagram 400, the time interval for the generation of the predicted temperature sequences with refined CNN-LSTM module may be set as [t, t_{f}] with t_{f} as the final time step.

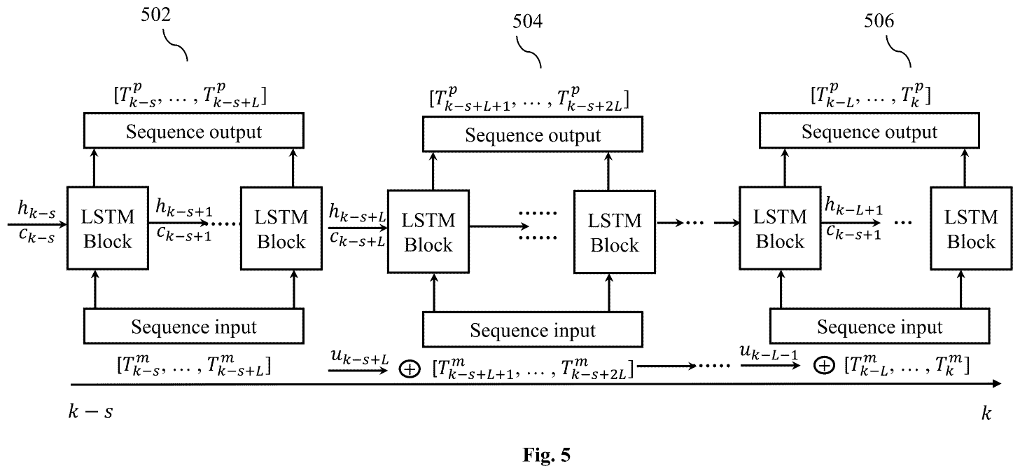

In embodiments of the disclosure, it was found that the combination of PID controller module 104 with trained CNN-LSTM module 114 boosted the accuracy of the temperature distribution prediction performed by trained CNN-LSTM module 114. The mechanism of the PID integration performed by PID controller module 104 in the prediction process performed by trained CNN-LSTM module 114 during the offline mode is illustrated in FIG. 5.

For the timing diagram shown in FIG. 5, it can be seen that the time step k is the final time step, where k is a value within [t−2Δt, t−Δt]. The overall prediction process extends over customized total response steps s and it is also assumed that target plane data are known before t−Δt. Additionally, initial internal states at k−s are assumed to be uninitialized.

As shown, in each of the response steps 502, 504, 506, the sequence that is provided as the input to trained CNN-LSTM module 114 contains information about the consecutive measured temperature sequences. The corresponding sequence outputs comprise the temperature distribution that were reconstructed based on the identified BESS thermal dynamics. Further, the internal states of the previous state propagate as the initial internal states for the next sequence and the transfer of internal states take place in the LSTM block. It can be seen that PID controller module 104 plays a role at each junction, by utilizing aggregated error signals from previous response steps to construct the control signal. This control signal is then added to the next input sequence and these steps then repeat continually until the final prediction at time step k is derived.

In embodiments of the disclosure, a Tree-structured Parzen Estimator (TPE) algorithm based on Bayesian optimization may be utilized by modules 104 and 114 to obtain the optimal set of PID parameters for PID controller module 104.

The TPE algorithm optimizes the criterion of Expected Improvement (EI) where on each optimization iteration or PID adjustment iteration, the algorithm returns the candidate set of hyper-parameters with the largest EI and gradually reaches convergence.

In an embodiment of the present disclosure, the TPE algorithm will utilize the training set of measured temperature sequences 202 and the series of known output temperature sequences 201 to perform a plurality of optimization steps or PID adjustment iterations, whereby each PID adjustment iteration comprises the steps of first selecting a unique series of measured temperature sequences associated with the PID adjustment iteration from the training set of measured temperature sequences. The TPE algorithm then determines an objective function for the TPE algorithm based on a Mean Absolute Error (MAE) error of a final output temperature Oₖ^{p} of the unique series of measured temperature sequences and a first-order difference of output temperature sequences of the unique series of measured temperature sequences. These two terms are defined in greater detail in the next section. A set of the PID parameters (Kₚ, Kᵢ, K_{d}) are then assigned as input for the objective function of the TPE algorithm. The TPE algorithm then computes a set of optimal PID parameters (K*ₚₒ, K*ᵢₒ, K*_{do}) for the PID adjustment iteration based on the input set of PID parameters (Kₚ, Kᵢ, K_{d}). Once all the PID adjustment iterations have been completed, the optimized PID parameters (K*ₚ, K*ᵢ, K*_{d}) are then obtained by computing the average of all the optimal PID parameters (K*ₚₒ, K*ᵢₒ, K*_{do}) of all the PID adjustment iterations.

In other words, it can be said that when the TPE algorithm is utilized, the metrics proposed for PID parameter adjusting are defined as the MAE error of the final temperature prediction and the first-order difference within the response steps to indicate oscillation in the PID prediction process.

For each sample k within [t−2Δ, t−Δt] with prior knowledge of known output temperature sequences before time step t−Δt in the offline mode, the objective criterion in the TPE algorithm to be minimized eₖ may be defined as:

$${e}_{k} = α \frac{1}{r \times c} {‖ {T}_{k}^{p} - {T}_{k}^{r} ‖}_{1} + β {\sum }_{i = 1}^{s - 1} \vert {\overline{T}}_{i}^{p} - {\overline{T}}_{i + 1}^{p} \vert , k ∈ [ t - 2 Δ t , t - Δ t ] , k - s ℒ \geq 0 \qquad ( 8 )$$

where α, β denote the customized weights of two errors and T̅ᵢ^{p} is the average value of surface temperature distribution at response step i. In embodiments of the disclosure, α, β may be set tosome initial values, e.g., (1, 1), (1, 0.5), and these initial values are typically within a range [0, 1], to show the relative importance attached to the two terms. After a few groups of values have been tested, the values of α, β that provide the best performance may then be selected.

The two terms represent the MAE error of the final temperature prediction and the first-order difference within the PID prediction process respectively, such that the prediction error and oscillation during the response steps are minimized. After the optimized PID parameters are obtained for each sample, they are averaged among all these Δt samples to compute the final optimized PID parameters for generation of predicted error and the online prediction mode.

Once the optimized PID parameters have been obtained, PID controller module 104 may then proceed to compute the predicted error sequences eₜ^{p} by obtaining the training set of measured temperature sequences 202 and the series of known output temperature sequences Tₜ^{r} 201. Another plurality of PID adjustment iterations are then carried out for each of the measured temperature sequences in the training set of measured temperature sequences 202 based on the optimized PID parameters (K*ₚ, K*ᵢ, K*_{d}) to obtain a series of error data samples, wherein each error data sample is associated with each PID adjustment iteration. Linear regression is then performed on the series of obtained error data samples to obtain the predicted error sequences eₜ^{p}, whereby the linear regression model is defined by a plurality of coefficient matrices associated with a time series of the series of error data samples.

In other words, it can be said that error data calculated in the PID correction at each response step based on samples within time steps [t−2Δt, t−Δt] are first obtained as historical data. Each error data sample entails s response steps, and within each response step is a sequence having [symbol] continuous time steps, and as a result, there are [symbol] time steps in total. Each error data sample eₖ or the matrix dimensions of this error sequence may be defined as:

$${e}_{k} = [ {e}_{k , 1} , … , {e}_{k , s} ] , k ∈ [ τ - 2 Δt , t - Δ t ] , {e}_{k , i} ∈ {ℝ}^{ℒ \times r \times c} , 1 \leq i \leq s \qquad ( 9 )$$

Therefore, with a total Δt number of samples having final target values within time interval [t−2Δt, t−Δt], each with s response steps under PID control, each error matrix in e_{k,i,j},j=1, . . . , [symbol] is reshaped as a r×c column vector. The flattened Δt×s× [symbol] error vector samples are concatenated afterwards for the calculation of linear regression coefficient matrices A, B in the linear regression function with the following form:

$${ε}_{j} = {[ {e}_{1 , 2 , j} , … , {e}_{1 , i , j} , … , {e}_{1 , s , j} \vert … \vert {e}_{Δ t , 2 , j} , … , {e}_{Δ t , i , j} , … , {e}_{Δ t , s , j} ]}^{T} , ∀ 1 \leq j \leq ℒ$$

$${A}_{j} = {ε}_{i} {ε}_{i - 1}^{†}$$

$${B}_{j} = {ε}_{i} - {A}_{j} {ε}_{i - 1}$$

where “|” marks different segments in error samples and † indicates a Moore-Penrose inverse of matrix.

With the recursive linear regression expression, based on Δt samples, the predicted error sequences 101 may be defined as:

$${e}_{t , i + 1 , j}^{p} = {A}_{j} {e}_{t , i , j} + {B}_{j} , ∀ 1 \leq i \leq s - 1 \qquad ( 10 )$$

The obtained optimized PID parameters 106 and predicted error sequences 101 (having s response steps) may then be utilized by PID controller module 104 and trained CNN-LSTM module 114 to generate refined predicted real temperature sequences Tₜ^{p} 116 across the battery.

With reference to FIG. 1, it can be seen that virtual sensor 100 is not provided with known reference values or known target output temperature sequences. Instead, PID controller module 104 will utilize predicted error sequences 101 together with optimized PID parameters 106 to generate control signal sequences uₜ 108. The control signal sequences uₜ 108 may then be combined with the associated measured temperature sequences of the battery at module 110. This combined signal is then provided to trained CNN-LSTM module 114 to generate refined predicted real temperature sequences Tₜ^{p} 116 across the battery, which may be defined as:

$${T}_{t}^{p} = \hat{𝒱} ( {u}_{t - ℒ} + {T}_{t}^{m} \vert {T}_{t - ℒ}^{p} ) \qquad ( 11 )$$

where [symbol] is the approximation of the reversed measuring process for data sequences and is dependent on previous time prediction and [symbol] establishes the identified dynamical temperature variation system and [symbol] represents the input sequence length.

Applying PID controller for the accuracy boosting in virtual sensor prediction enhances the interpretability of the CNN-LSTM-PID framework. Utilizing the features of time-series data, CNN-LSTM simulates plane temperature variation. Thus the PID controller imposed on the network demonstrates the correction effect to compensate for the prediction and makes the error approaches zero.

A summary of the PID Accuracy Boosting algorithm in accordance with embodiments of the disclosure is summarized in Algorithm 1 below.

In embodiments of the disclosure, based on the analysis discussed in the subsequent section “Analysis of PID parameter tuning based on control theory”, a physical process estimated with the CNN-LSTM module may be deemed as a first-order transfer function. The feasible TPE search space for Kₚ, Kᵢ, K_{d} parameters may also be analyzed based on the PID transfer function and the control theory analysis. Hence, it was determined that Kₚ, Kᵢ may comprise values that are “positive” while K_{d} may comprise a zero value. Additionally, it should be noted that these three parameters Kₚ, Kᵢ, K_{d} may not comprise values that are too large else, the simulated neural network system would produce output values that are unstable. The input values for the neural network are also typically normalized within the range [0, 1] or [−1, 1] to avoid numerical issues. Therefore, based on the considerations set out above, the initial TPE search space for the parameters Kₚ, Kᵢ, K_{d} may be set within a range of 0 and 1.

Algorithm 1: PID Accuracy Boosting Algorithm

Data: Trained CNN-LSTM, sample number Δt, response step s, current step t,
Result:
Offline mode: Optimized PID parameters Kₚ*, Kᵢ*, K_{d}*, and predicted error for normal mode
Normal mode: Battery surface temperature sequence prediction results Tₜ^{p}
Begin
Offline mode:
Set TPE search space ω for Kₚ, Kᵢ, K_{d}
For t − 2Δt ≤ k ≤ t − Δt, do

| { | Tₖ^{p}, T̅ᵢ^{p} ← with input sequences Tₖ₋ₛ^{m}, ..., Tₖ^{m}, | |
|---|---|---|
| | K_{p,k}, K_{i,k}, K_{d,k} ∈ ω, calculate: | |
| | (1) | output sequences of the trained CNN-LSTM module, |
| | (2) | the error between known target output temperature sequences and output |
| | | sequences of the trained CNN-LSTM module, and |
| | (3) | control signals in a discretized time domain. |

Define TPE optimization criterion to be minimized.
K_{p,k}*, K_{i,k}*, K_{d,k}* ← TPE computation results

}
End
Kₚ*, Kᵢ*, K_{d}* ← mean (K_{p,k}*, K_{i,k}*, K_{d,k}*)
For t − 2Δt ≤ k ≤ t − Δt, do

| { | Tₖ^{p} ← with input sequences Tₖ₋ₛ^{m}, ..., Tₖ^{m}, Kₚ*, Kᵢ*, K_{d} | |
|---|---|---|
| | calculate: | |
| | (1) | output sequences of the trained CNN-LSTM module, |
| | (2) | the error between known target output temperature sequences and output |
| | | sequences of the trained CNN-LSTM module, and |
| | (3) | control signals in a discretized time domain. |

eₖ ← Tₖ^{r} − Oₖ

}
End
A, B ← Linear regression with error samples eₖ
e_{t,i+1,j}^{p} ← Error prediction with error samples eₖ and A, B
Normal mode:
Tₜ^{p} ← Sequence prediction Tₜ^{p} = \hat{V}( [symbol] + Tₜ^{m}| [symbol] ) , with predicted error eₜ^{p} , input
sequences Tₜ₋ₛ^{m}, ..., Tₜ^{m} and optimized PID parameters
End

From time to time, when the prediction error of the virtual sensor exceeds certain thresholds, parameters of the virtual sensor will need updating. During this adjustment period, the CNN-LSTM network and PID compensator will be adjusted based on the latest data of the system. This scenario can happen owing to the varying thermal dynamics of the system, degradation of the battery, fluctuations in battery operating conditions.

In embodiments of the present disclosure, when this happens, the PID controller module is further configured to obtain another set of optimized PID parameters (K*ₚ, K*ᵢ, K*_{d}); obtain another set of predicted error sequences; obtain another measured temperature sequences of the battery; and trigger the CNN-LSTM module to generate another refined predicted series of real temperature sequences across the battery based on the obtained another set of optimized PID parameters (K*ₚ, K*ᵢ, K*_{d}); the another set of predicted error sequences and the another measured temperature sequences of the battery.

### Analysis of PID Parameter Tuning Based on Control Theory.

Coefficients are crucial in PID algorithm as they influence the control outcomes, including steady-state error, oscillation, overshoot and other time domain characteristics. In this disclosure, the control idea is integrated to enhance the prediction results of the battery thermal prediction neural network model. Hence, the dynamics of the trained network should be approximated to design an appropriate controller for the trained CNN-LSTM.

To approximate dynamics of neural networks, construction of network dynamic equations can be one potential way to represent feedforward network structures. However, the dynamic representation of neural network layers can be complicated particularly when convolutional operations are involved. In this disclosure, the understanding of the battery surface thermal model is leveraged in order to adjust the PID parameters, under the assumption that the CNN-LSTM model is designed to reflect such a physical dynamic system.

In order to do so, the thermal dynamics of a battery is first analyzed. In an embodiment of this disclosure, a 25 Ah pouch battery cell which was exposed to natural convection conditions is used to construct the thermal model. It is assumed that the heat generation is normally homogeneous within the battery cell. The heat transfer partial differential equation (PDE) to describe the thermal behavior of the battery cell may then be formulated as:

$${C}_{p} ρ \frac{dT ( k )}{dt} = ∇ ( k ∇ T ( k ) ) + \dot{Q} ( k ) \qquad ( 12 )$$

with Neumann boundary condition:

$$\frac{\partial T}{\partial ϵ} = {\dot{Q}}_{conv , j} = {h}_{j} {A}_{j} ( {T}_{s} - {T}_{amb} ) \qquad ( 13 )$$

where in ∈ represents the direction of the normal vector of each battery surface, Cₚ, ρ, and k are the specific heat capacity, density, and thermal conductivity of the cell, \dot{Q} and \dot{O}_{conv,j} denote the heat generation rate of the battery and the heat dissipation rate of the battery to the environment, respectively, hⱼ and Aⱼ are the convection coefficient and battery surface area that is exposed to the environment of surfaces perpendicular to the different axis, respectively.

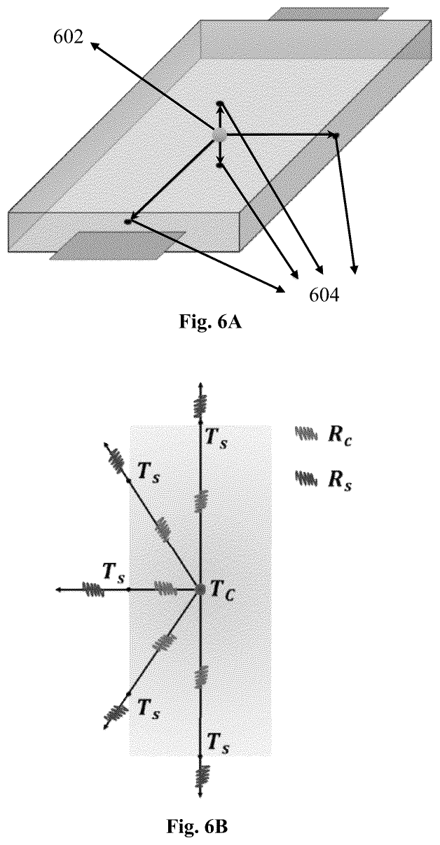

Several may assumptions then be made to simplify the analysis:
Heat generation within the battery cell is leveraged to the centre of the pouch battery as \dot{Q}_{c} as shown in FIG. 6A where 602 represents a heat generation point and 604 represents surface points. Such an assumption is usually made in works relating to battery lumped thermal modelling.
Cₚ, ρ, and k are considered homogeneous in cell active materials and are not affected by the temperature gradient.
Heat conduction inside the battery only happens between surface nodes and the centre node. Hence, the 3D heat transfer problem is decomposed into many 2 nodes lumped thermal models.

Based on the above assumptions, the heat transfer partial differential equation is discretized using the finite difference method as:

$$\frac{{T}_{c} ( k + 1 ) - {T}_{c} ( k )}{Δ t} = \frac{\dot{Q} ( k )}{{C}_{c}} + k \frac{2 {T}_{s} ( k ) - 2 {T}_{c} ( k )}{{C}_{c} {Δξ}^{2}}$$

$$\frac{{T}_{s} ( k + 1 ) - {T}_{s} ( k )}{Δ t} = \frac{{\dot{Q}}_{conv , j} ( k )}{{C}_{s}} + k \frac{2 {T}_{c} ( k ) - 2 {T}_{s} ( k )}{{C}_{s} {Δξ}^{2}}$$

$${\dot{Q}}_{conv , j} ( k ) = {h}_{j} {A}_{j} ( {T}_{s} ( k ) - {T}_{amb} )$$

where ξ is the polar coordinate axis determined by the positions of surface points and the heat generation center. T_{c}, Tₛ and T_{amb} are the center node temperature, surface temperature and the ambient temperature, respectively. Here C_{c} and Cₛ denote the thermal capacity of the cell core and the surface and are defined as the multiplication of respective density and specific heat capacity. Then by replacing the spatial term in the finite difference form with the lumped thermal resistance as shown in FIG. 6B, the equation can be further simplified as:

$${T}_{c} ( k + 1 ) - {T}_{c} ( k ) = \frac{\dot{Q} ( k )}{{C}_{c}} Δ t + \frac{{T}_{s} ( k ) - {T}_{c} ( k )}{{C}_{c} {R}_{c}} Δ t$$

$${T}_{s} ( k + 1 ) - {T}_{s} ( k ) = \frac{{\dot{Q}}_{conv , j} ( k )}{{C}_{c}} Δ t + \frac{{T}_{s} ( k ) - {T}_{c} ( k )}{{C}_{c} {R}_{s}} Δ t$$

$${\dot{Q}}_{conv , j} ( k ) = \frac{{T}_{s} ( k ) - {T}_{amb}}{{R}_{s}}$$

where R_{c} and Rₛ are the lumped thermal resistance of internal cell and cell-environment interface, respectively. The heat generation rate is related to battery current and voltage, thus influencing the temperature variation speed, which is closely related to the time constant of the CNN-LSTM approximated system analysis. Therefore, though not explicitly involved in the input for the CNN-LSTM, the battery physical quantities are reflected in PID design.

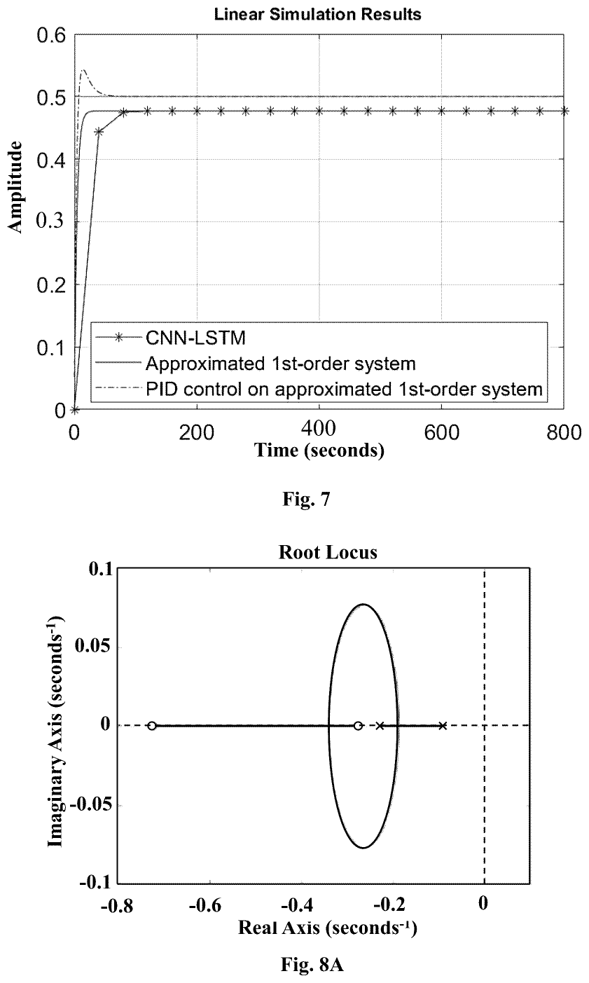

Since the above thermal equations only contain first order derivatives of surface temperature variations with regard to time, the transfer function of the battery surface temperature can be approximated with a first-order linear system as an analytical model, though the real physical system can be nonlinear. To approximate the first-order transfer function, step response of the system is derived first with a constant value sequence as the input for the CNN-LSTM. With 0.5 as the input signal, the corresponding step response is depicted in FIG. 7.

The steady-state value of the CNN-LSTM is constant, thus it may be represented with a first-order closed-loop transfer function

$$\frac{K}{Ts + 1} ,$$

with K as the gain of the system. Time constant T may then be calculated following that the response value is 95% of the steady value when time equals to 3T. As for the step response, the system output should track the input, meaning that the steady-state value should be equal to the input value. Therefore, the PID transfer function is integrated to eliminate steady-state error. In the frequency domain, the transfer function for PID algorithm may be defined as:

$$PID ( s ) = {K}_{p} + \frac{{K}_{i}}{s} + {K}_{d} s \qquad ( 14 )$$

For the first-order system, proportional control can be used to alter the rise time and settling time. Together with integral control and derivative control, the steady-state error can be reduced with a smoother response in the time domain. When the PID parameters are adjusted in “offline” mode, with a known target output value, the system transfer function with block diagram in the offline mode may be defined as:

$$Y ( s ) = \frac{PID ( s ) \hat{V} ( s )}{1 + PID ( s ) \hat{V} ( s )} Ref ( s ) + \frac{\hat{V} ( s )}{1 + PID ( s ) \hat{V} ( s )} X ( s ) \qquad ( 15 )$$

where \hat{V}(s) is the approximated transfer function of CNN-LSTM, Y(s) is the system output, X(s) is the step input, and Ref(s) is the reference step response value. For the explicit form of the transfer function, more detailed analysis is provided as follows.

The first term in equation (15) denotes the response brought by the reference input signal and the second term in equation (15) denotes the response brought by the input sensor signal:

$$\frac{PID ( s ) \hat{V} ( s )}{1 + PID ( s ) \hat{V} ( s )} Ref ( s ) = \frac{K ( {K}_{d} {s}^{2} + {K}_{p} s + {K}_{i} )}{( {KK}_{d} + T ) {s}^{2} + ( {KK}_{p} + 1 ) s + {KK}_{i}} Ref ( s ) \qquad ( 16 a )$$

$$\frac{\hat{V} ( s )}{1 + PID ( s ) \hat{V} ( s )} X ( s ) = \frac{Ks}{( {KK}_{d} + T ) {s}^{2} + ( {KK}_{p} + 1 ) s + {KK}_{i}} X ( s ) \qquad ( 16 b )$$

where the two terms have the same characteristic equation of the closed-loop subsystem. On a case-by-case basis:
If Kᵢ=0: For steady-state response, the term

$${lim}_{s \to 0} Y ( s ) = \frac{{KK}_{p} + K}{{KK}_{p} + 1} Ref ( s )$$

deviates from the step input value since K≠1 for CNN-LSTM identified system. Thus Kᵢ≠0.
Kᵢ≠0: In equation (16a), steady-state response equals to Ref(s). As for the poles, since all coefficients of the second-order characteristic equation are larger than zero, all poles lie in the left half complex plane. As for zeros, since all coefficients of the numerator are larger than zero, all zeros lie in the left half complex plane as well. In equation (16b), the zero point lies at the origin, indicating the steady-state value is zero.

The discussion for K_{d} follows a similar procedure and K_{d}=0 is viable. For the illustration of PID control effect of the approximated system, coefficients are set as Kₚ=0.5, Kᵢ=0.1, K_{d}=1 and the controlled system output is in FIG. 7, with zero steady-state error. For the stability analysis of the chosen set of PID parameters, root locus analysis can be used as the stability criterion. It is a graphical method to examine the change of roots with the variation of the gain in a feedback system. The root locus plots the poles of the closed loop transfer function in the complex s-plane as a function of gain.

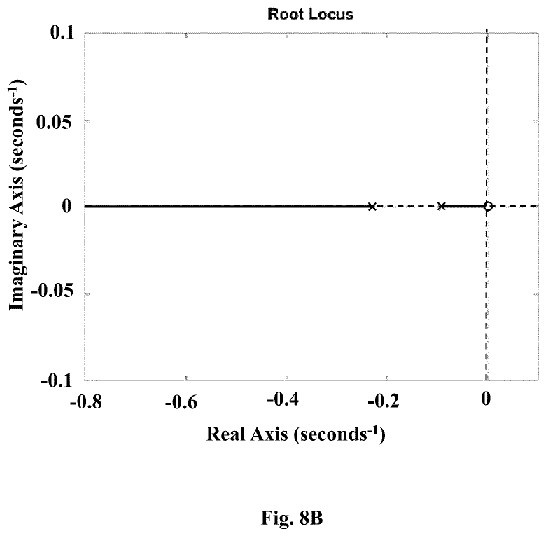

The corresponding stability analysis is shown in the root locus plot in FIG. 8A for the first term in equation (15) and in FIG. 8B for the second term in equation (15). Root locus all lie in the left half complex plane, indicating that the corresponding terms in the time domain have attenuated oscillation, thus leading to stability of the PID controlled system.

Since the change of PID coefficients within the approximated system does not change the fact that poles and zeros lie in the left half complex plane, estimation is required based on the CNN-LSTM to seek the ranges for PID coefficients. For instance, the change of network input X(s) cannot be too large at each step, otherwise, with trained CNN-LSTM, the output tends to diverge from the expectation. With the assessed feasible value ranges, a TPE optimization algorithm may be applied (as described in the previous sections) to find the optimized PID parameters (K*ₚ, K*ᵢ, K*_{d}).

### Indicators of Performance

In embodiments of this disclosure, training and validation loss within the CNN-LSTM neural network training process may be measured using mean squared error (MSE) which may be defined as:

$$MSE = \frac{1}{n} {\sum }_{i = 1}^{n} {( {y}_{i} - {y}_{i}^{*} )}^{2} \qquad ( 17 )$$

where yᵢ denotes the element in the predicted vector and y*ᵢ is the corresponding target value.

Therefore, the training process of the CNN-LSTM aims to minimize the MSE between the network's output and a target value, i.e., the optimal network weights may be defined as:

$${ω}^{*} = arg {min}_{ω} {‖ \hat{𝒱} ( ω , {T}_{t}^{m} \vert {O}_{t - ℒ} ) - {T}_{t}^{r} ‖}_{2}^{2} \qquad ( 18 )$$

The difference between real temperature and the predicted temperature with PID correction is measured with mean absolute error (MAE) and this may be defined as:

$$MAE = {\sum }_{i = 1}^{n} \vert {y}_{i} - {y}_{i}^{*} \vert \qquad ( 19 )$$

such that the errors are directly calculated in terms of temperature unit.

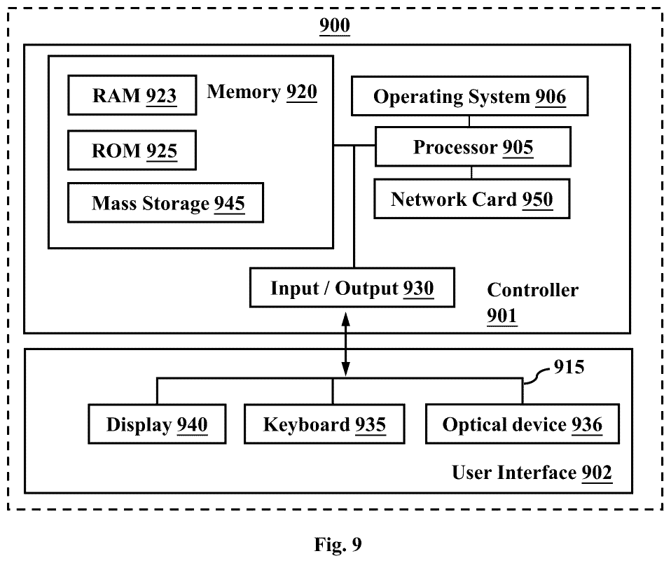

In accordance with embodiments of the present disclosure, a block diagram representative of components of processing system 900 that may be provided within PID controller module 104 to carry out the functions of the PID controller module, or any other modules of the system is illustrated in FIG. 9. One skilled in the art will recognize that the exact configuration of each processing system provided within these modules may be different and the exact configuration of processing system 900 may vary and the arrangement illustrated in FIG. 9 is provided by way of example only.

In embodiments of the disclosure, processing system 900 may comprise controller 901 and user interface 902. User interface 902 is arranged to enable manual interactions between a user and the computing module as required and for this purpose includes the input/output components required for the user to enter instructions to provide updates to each of these modules. A person skilled in the art will recognize that components of user interface 902 may vary from embodiment to embodiment but will typically include one or more of display 940, keyboard 935 and optical device 936.

Controller 901 is in data communication with user interface 902 via bus 915 and includes memory 920, processor 905 mounted on a circuit board that processes instructions and data for performing the method of this embodiment, an operating system 906, an input/output (I/O) interface 930 for communicating with user interface 902 and a communications interface, in this embodiment in the form of a network card 950. Network card 950 may, for example, be utilized to send data from these modules via a wired or wireless network to other processing devices or to receive data via the wired or wireless network. Wireless networks that may be utilized by network card 950 include, but are not limited to, Wireless-Fidelity (Wi-Fi), Bluetooth, Near Field Communication (NFC), cellular networks, satellite networks, telecommunication networks, Wide Area Networks (WAN) and etc.

Memory 920 and operating system 906 are in data communication with CPU 905 via bus 910. The memory components include both volatile and non-volatile memory and more than one of each type of memory, including Random Access Memory (RAM) 923, Read Only Memory (ROM) 925 and a mass storage device 945, the last comprising one or more solid-state drives (SSDs). One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory 920 may include a kernel and/or programming modules such as a software application that may be stored in either volatile or non-volatile memory.

Herein the term “processor” is used to refer generically to any device or component that can process such instructions and may include: a microprocessor, microcontroller, programmable logic device or other computational device. That is, processor 905 may be provided by any suitable logic circuitry for receiving inputs, processing them in accordance with instructions stored in memory and generating outputs (for example to the memory components or on display 940). In this embodiment, processor 905 may be a single core or multi-core processor with memory addressable space. In one example, processor 905 may be multi-core, comprising—for example—an 8 core CPU. In another example, it could be a cluster of CPU cores operating in parallel to accelerate computations.

An exemplary method for computing spatial-temporal temperature measurements of a battery using a virtual sensor in accordance with embodiments of the present disclosure is set out in the steps below. The steps of the method as implemented by the virtual sensor illustrated in FIG. 1 are as follows:
Step 1: triggering, using a Proportional-Integral-Derivative (PID) controller module communicatively coupled to a trained convolutional neural network—long-short-term memory (CNN-LSTM) module, the trained CNN-LSTM module to generate refined predicted series of real temperature sequences Tₜ^{p} across the battery based on a set of optimized PID parameters (K*ₚ, K*ᵢ, K*_{d}), predicted error sequences eₜ^{p}, and a series of measured temperature sequences Tₜ^{m} of the battery;
Step 2: whereby the CNN-LSTM module was trained based on a training set of spatial-temporal temperature measurements of the battery, and
Step 3: whereby the optimized PID parameters were generated based on a training set of measured temperature sequences and a series of known output temperature sequences Tₜ^{r}.

A process for computing spatial-temporal temperature measurements of a battery using a virtual sensor is illustrated in FIG. 10. Process 1000 begins at step 1002, with the virtual sensor receiving a series of measured temperature sequences Tₜ^{m} of the battery. Process 1000 then proceeds to step 1004.

At step 1004, process 100 then proceeds to trigger, using a Proportional-Integral-Derivative (PID) controller module communicatively coupled to a trained convolutional neural network—long-short-term memory (CNN-LSTM) module, the trained CNN-LSTM module to generate refined predicted series of real temperature sequences Tₜ^{p} across the battery based on a set of optimized PID parameters (K*ₚ, K*ᵢ, K*_{d}), predicted error sequences eₜ^{p}, and a series of measured temperature sequences Tₜ^{m} of the battery. Process 1000 had previously trained the CNN-LSTM module based on a training set of spatial-temporal temperature measurements of the battery, and process 1000 had previously generated the optimized PID parameters based on a training set of measured temperature sequences and a series of known output temperature sequences Tₜ^{r}. Process 1000 then ends.

### Experiment

An investigation concerning the effectiveness and accuracy of the boosting performance of the virtual sensing framework was conducted based on the temperature distribution of generated data of a one-dimensional testing system and the battery cell surface.

Within the CNN-LSTM-PID virtual sensing framework, training and validation of the CNN-LSTM was built on a desktop PC with a 1.80 GHz Intel® Xeon® Silver 4108 processor and 32 GB of memory using the PyTorch library with CUDA backend. For the PID accuracy boosting, without loss of generality, for each element in data vectors, the same parameters for the PID controller were adopted, based on which the accuracy boosting effect can be demonstrated.

For simplicity, time steps in simulation settings are referred to with the notation (1, 2, . . . ) and in the figures, the time steps are in seconds. Regarding the notations, “Direct prediction” represents the prediction of the current input sequence, i.e., [ [symbol] , . . . , Tₜ₋₁^{m}, Tₜ^{m}]T. “W/O PID” denotes the evolution with merely internal states transfer between LSTM blocks, to predict the trajectory of temperature distribution over a long-time scale. “Offline” indicates the offline PID tuning mode, during which the target information is given. “Online” indicates the normal operation of the virtual sensor's prediction mode, whereby tuned PID parameters and the predicted error data as obtained from the offline mode are provided to the virtual sensor, and whereby prior knowledge of reference outputs are not provided. “Basic” indicates results generated with basic network whereas “Opt” indicates results generated using a hyper-parameter optimized network. “Opt direct” denotes the direct prediction based on the current input sequence. “Opt evolution” denotes the prediction on future time steps based on the internal propagation states of LSTM cells.

### Dataset Description

Two kinds of datasets were used to validate the proposed virtual sensing platform and the performance of PID compensator. The first type of dataset to be used is the one-dimensional data and the second type of dataset is the two-dimensional data of battery surface temperature.

The one-dimensional temperature distribution dataset was generated based on the following thermal equation:

$$ρ {C}_{p} \frac{dT}{dt} = K \frac{{\partial }^{2} T}{\partial {x}^{2}} + \dot{q} \qquad ( 20 )$$

where ρ and Cp are the density and the specific heat capacity of the battery cell material, K is the thermal conductivity of the cell material along the X-axis and \dot{q} is a constant.

As shown in Table 1, the scenarios in this example are chosen based on the operational pattern of the batteries.

### Generated Data Scenarios.

TABLE 1

| Scenario | Heat generation rate/Current | Sampling time interval |
|---|---|---|
| 1 (1D) | \dot{q} = 5 × 10³ W/m³ | tᵢ = 10 s |
| 2 (1D) | \dot{q} = 2 × 10⁴ W/m³ | tᵢ = 10 s |
| 3 (2D) | I = 25 A (1C) | tᵢ = 10 s |
| 4 (2D) | I = 75 A (3C) | tᵢ = 3 s |
| 5 (2D) | I = 75 A (3C) | tᵢ = 5 s |

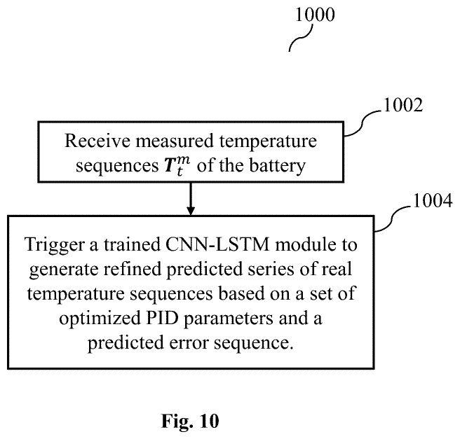

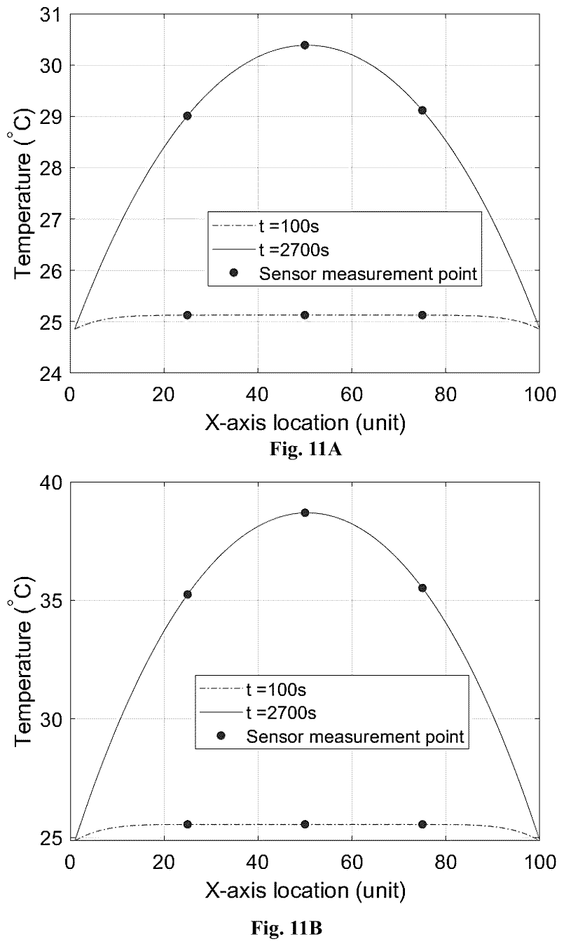

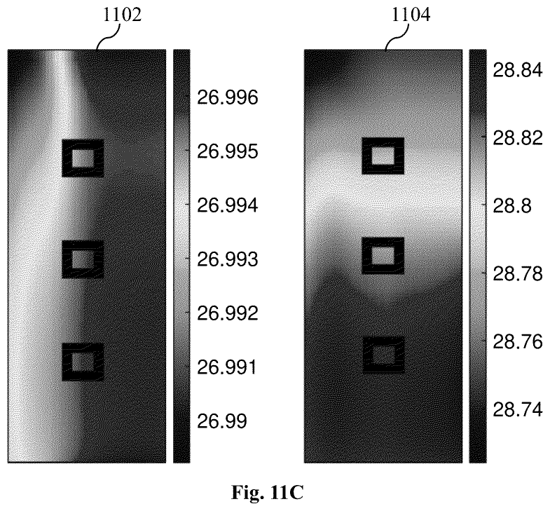

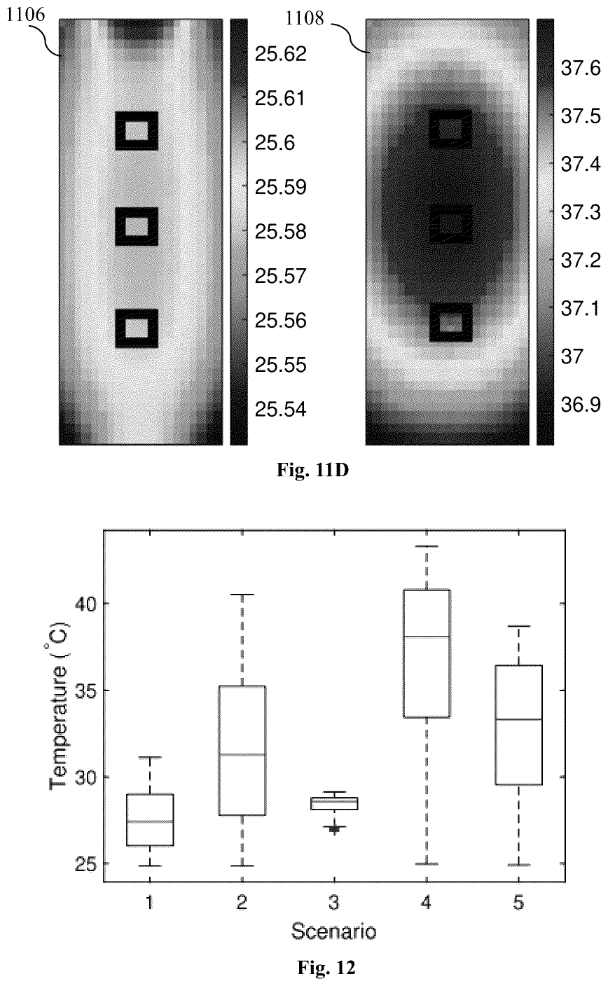

FIGS. 11A and 11B show the examples of temperature distribution data under two constant volumetric heat sources \dot{q}ₗ and \dot{q}₂, denoted as scenario 1 and 2 respectively. The sampling intervals tᵢ of the generated data for both scenarios are 10 s. The temperature is the highest in the middle part and is the same as the ambient temperature on both sides. As time increases, the temperature gets higher; and with larger \dot{q} value, the temperature is higher at the same time point. The dots in FIGS. 11A and 11B are used to indicate sensor measuring points. Scenario 2 holds higher temperature since the battery heat generation rate \dot{q} is set to larger values.

To collect 2D battery temperature distribution data, the 3D battery model is built in ANSYS FLUENT 2021 R1 using the MSMD battery module with the NTGK electrochemical empirical model. A 25 Ah pouch battery (199×106×10 mm3) with lithium manganese oxide (LiMnO₄) and Lithium graphite (LiC₆) as positive and negative electrode material, respectively, is used here for simulation. The adopted battery cell is formed by multiple layers of the combination of different components including a positive electrode, negative electrode, separator, positive current collector, and negative current collector and these components are compressed together in a sandwich structure. For thermal analysis, the material of each sandwich layer is considered the same and specified as cell material or active material. Additionally, the material of the positive tab and negative tab is assumed to be made from aluminum and copper, respectively. Cell material is then taken as the overall NMC battery cell material.

The battery cell is defined to operate within the state of charge (SOC) range from 10% to 90%. The cooling method of thermal modeling is natural convection. The initial temperature of the battery cell for each discharging or charging cycle is set as 298 K. The thermal property setup of the adopted battery model is shown in Table 2 below.

TABLE 2
Parameters of NMC battery simulation model.

| Specifications | Value | |
|---|---|---|
| Convection coefficient | 5 | W/m² K |
| Cell thermal conductivity k_{cell} | 18.4 | W/m K |
| Cell density ρ_{cell} | 2092 | kg/m³ |
| Cell specific heat C_{p, cell} | 678 | J/kg K |
| Negative tab thermal conductivity k_{ntab} | 387.6 | W/m K |
| Negative tab density ρ_{ntab} | 8978 | kg/m³ |
| Negative tab specific heat C_{p, ntab} | 381 | J/kg K |
| Positive tab thermal conductivity k_{ptab} | 202.4 | W/m K |
| Positive tab density ρ_{ptab} | 2719 | kg/m³ |
| Positive tab specific heat C_{p, ptab} | 871 | J/kg K |

The convection coefficient represents the amount of heat dispatched from the battery to the environment every square meter concerning the temperature difference between the battery and the environment. The thermal conductivity kⱼ represents the heat diffusion property of the material. The specific heat C_{p,j} is the amount of thermal energy that 1 kg of the material needs to absorb to increase by 1 K. Here j denotes different components of the battery: cell, negative tab, and positive tab. In the present disclosure, the material in one component is considered to be homogeneous, which implies that its thermal property is set as a constant and does not change according to position or other influences.

The dataset of the 2D temperature distribution comprises of scenario 3, scenario 4, and scenario 5. Scenario 3 is generated when the battery charging C-rate is 1C and the sampling time interval tᵢ is 10 s. Scenarios 4 and 5 are under 3C battery charging C-rate with sampling time intervals 3s and 5s respectively. FIG. 11C illustrates examples of temperature distribution for scenario 3 when I=1C and tᵢ=10s. In particular, temperature distribution 1102 shows the temperature distribution when t=100 s and temperature distribution 1104 shows the temperature distribution when t=2700 s. FIG. 11D illustrates examples of temperature distribution for scenario 5 when I=3C and tᵢ=5s. In particular, temperature distribution 1106 shows the temperature distribution when t=50 s and temperature distribution 1108 shows the temperature distribution when t=850 s.

As time increases, for 1C charging, the highest temperature area tends to concentrate on the bottom side of the cell; and for 3C charging, the highest temperature area tends to concentrate in the center of the cell. The three black blocks each with 3×3 size indicate sensor measuring points. It can be seen that the thermal image in scenario 4 is similar to that in scenario 5. Scenarios 4 and 5 hold higher temperature since the charging C-rate is set larger (see FIG. 12).

### CNN-LSTM Training

Based on the above generated data, for CNN-LSTM training, the input data includes the sensor measuring points and the remaining points are padded with the average value of the measurements to facilitate data preprocessing. Since the neural network is sensitive to data scale, the input vectors are scaled to the range of [0, 1] with min-max normalization. Since in 1D data, the temperature distribution expands along the X-axis, 2D convolution is not imposed on such 1D data, thus they directly pass through the LSTM network after preprocessing.

In the training procedure, L2 regularization is applied by adding the L2 norm of network weight to the loss function and this may be defined as:

$${ω}^{*} = arg {min}_{ω} {‖ \hat{𝒱} ( ω , {T}_{t}^{m} \vert {O}_{t - ℒ} ) - {T}_{t}^{r} ‖}_{2}^{2} + λ {‖ ω ‖}^{2} \qquad ( 21 )$$

where λ is the regularization coefficient that belongs to hyper-parameters. In this way, an overfitting problem can be effectively circumvented as the network weights tend to generalize for varied data. Besides, since the L2 norm of network parameters are minimized, the network will be less sensitive to small noise or disturbances in input.

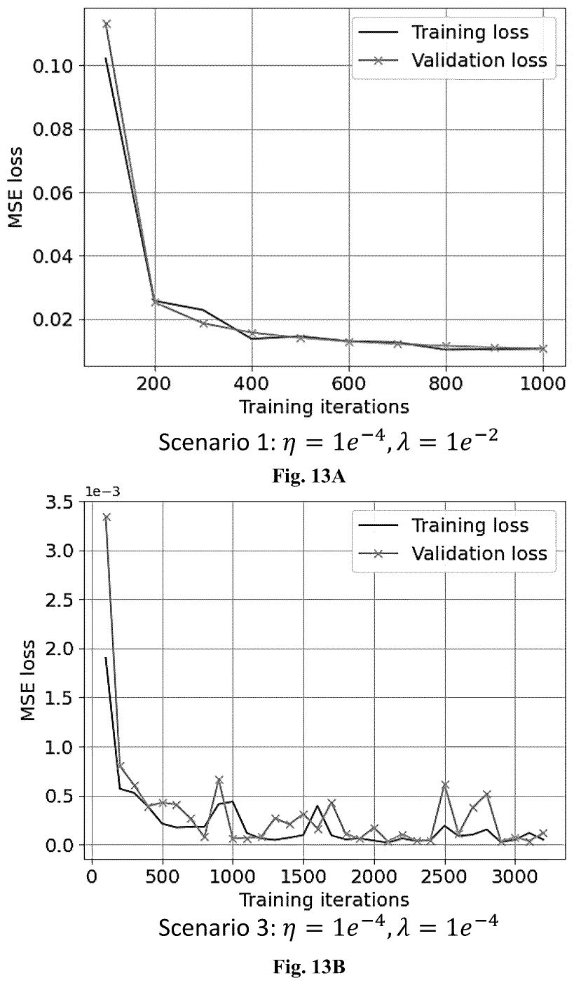

After some initial tests, it was found that the computationally efficient Adam optimizer showed better results than other candidates, such as the classic stochastic gradient descent (SGD), RMSProp and Adagrad. Therefore, Adam was used for the training of the proposed forecasting framework with recommended default momentum. In mini-batch learning, the adopted batch size was set to 64, and the sequence length [symbol] of input and output is 4 in consecutive time steps. The training and validation loss curves with different sets of hyper-parameters are demonstrated in FIGS. 13A and 13B. FIG. 13A illustrates the training and validation loss curves generated under scenario 1 with a learning rate η=1e⁻⁴ and weight decay L2 regularization coefficient λ=1e⁻² and FIG. 13B illustrates the training and validation loss curves generated under scenario 3 with a learning rate η=1e⁻⁴ and weight decay L2 regularization coefficient A 1e⁻⁴.

Different learning rate q and weight decay (L2 regularization coefficient A) are tested to compare the performance of CNN-LSTM, other scenarios have similar results. More MSE error results with K-fold cross validation are listed in Table 3 below.

TABLE 3
10-fold cross validation mean squared error.

| | Hyper-parameters | Training MSE | Validation MSE |
|---|---|---|---|
| Scenario 1 | η = 1e⁻⁴, λ = 1e⁻² | 1.056e−2 | 1.06e−2 |
| | η = 2e⁻⁴, λ = 1e⁻³ | 2.28e−4 | 2.10e−4 |
| Scenario 2 | η = 1e⁻⁴, λ = 1e⁻² | 1.09e−2 | 1.07e−2 |
| | η = 20⁻⁴, λ = 1e⁻³ | 2.26e−4 | 2.30e−4 |
| Scenario 3 | η = 1e⁻⁴, λ = 1e⁻⁴ | 4.90e−5 | 1.17e−4 |
| | η = 2e⁻⁴, λ = 0 | 3.02e−5 | 8.29e−4 |
| Scenario 4 | η = 1e⁻⁴, λ = 1e⁻⁴ | 6.65e−5 | 2.22e−4 |
| | η = 2e⁻⁴, λ = 0 | 1.74e−5 | 3.34e−3 |
| Scenario 5 | η = 2e⁻⁴, λ = 0 | 3.31e−5 | 2.09e−3 |
| | η = 1e⁻⁴, λ = 1e⁻³ | 8.66e−5 | 2.92e−4 |

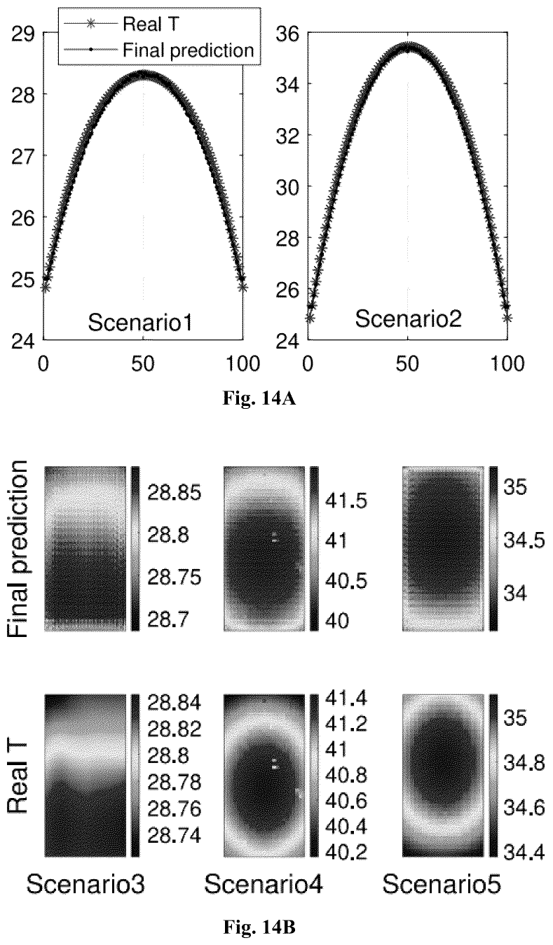

Validation outputs within different training iterations are demonstrated in FIGS. 14A and 14B to display the training performance. In particular, FIG. 14A illustrates one-dimensional data and FIG. 14B illustrates two-dimensional data. In 1D data, it can be seen that the final prediction values of trained CNN-LSTM approach the real value after the training iterations. Similarly, for 2D data, the predicted range of temperature and the distribution approximate the real value along the training, giving coherent results as the validation curves. The results also serve as the baseline to compare with the performance with PID accuracy boosting algorithm.

### Offline Optimization of PID Parameters

With the trained CNN-LSTM approximating the real physical system, a 1st-order linear system transfer function is applied to simulate the response of the CNN-LSTM. The coefficients of gain and time constant of the 1st-order system for the trained CNN-LSTM are shown in Table 4 below.

TABLE 4
Approximated 1st-order system.

| | Hyper-parameters | K | T (s) |
|---|---|---|---|
| Scenario 1 | η = 1e⁻⁴, λ = 1e⁻² | 1.0945 | 11.5093 |
| | η = 2e⁻⁴, λ = 1e⁻³ | 0.9418 | 13.0570 |
| Scenario 2 | η = 1e⁻⁴, λ = 1e⁻² | 1.0991 | 11.5606 |
| | η = 2e⁻⁴, λ = 1e⁻³ | 0.9858 | 13.2151 |
| Scenario 3 | η = 1e⁻⁴, λ = 1e⁻⁴ | 1.0026 | 14.1464 |
| | η = 2e⁻⁴, λ = 0 | 1.0481 | 12.5390 |
| Scenario 4 | η = 1e⁻⁴, λ = 1e⁻⁴ | 1.0039 | 3.8052 |
| | η = 2e⁻⁴, λ = 0 | 1.0039 | 3.8452 |
| Scenario S | η = 2e⁻⁴, λ = 0 | 1.0504 | 6.3430 |
| | η = 1e⁻⁴, λ = 1e⁻³ | 1.0039 | 6.3333 |

When the charging C-rate rises from 1C to 3C in scenario 4 and 5, in the approximated linear transfer function, the time constant T is shorter, meaning that the rise of temperature is faster.

As the gains are not equal to 1, there exists the steady-state error compared with the step input. Therefore, it reveals the existence of error between the prediction of the CNN-LSTM and the target value, where PID accuracy boosting algorithm will display the effect to narrow the gap.

In the offline tuning of PID parameters, the adjustment using TPE approach follows the criterion in equation (9). Optimized PID parameters are obtained such that the prediction error and oscillation during the response steps are minimized. The adjusted PID parameters and the magnitude limitation of control signal u are shown in Table 5 below. The PID parameters can then be used for the normal prediction mode, i.e., in the time period [t, t_{f}], during which the target values are unknown.

TABLE 5
Optimized PID parameters.

| | Hyper-parameters | Kₚ | Kᵢ | K_{d} | \|ū\| |
|---|---|---|---|---|---|
| Scenario 1 | η = 1e⁻⁴, λ = 1e⁻² | 0.983 | 0.83 | 0.1067 | 0.0315 |
| | η = 2e⁻⁴, λ = 1e⁻³ | 0.1744 | 0.2259 | 0.0266 | 0.3049 |
| Scenario 2 | η = 1e⁻⁴, λ = 1e⁻² | 0.5411 | 0.0833 | 0.0657 | 0.7717 |
| | η = 2e⁻⁴. λ = 1e⁻³ | 0.5883 | 0.4753 | 0.0868 | 0.9115 |
| Scenario 3 | η = 1e⁻⁴, λ = 1e⁻⁴ | 0.5931 | 1.2912 | 0.0206 | 0.0251 |
| | η = 2e⁻⁴, λ = 0 | 0.3019 | 1.1158 | 0.7793 | 0.022 |
| Scenario 4 | η = 1e⁻⁴, λ = 1e⁻⁴ | 0.5892 | 0.7629 | 0.7603 | 0.0178 |
| | η = 2e⁻⁴, λ = 0 | 0.0102 | 0.5678 | 0.4735 | 0.0337 |
| Scenario 5 | η = 2e⁻⁴, λ = 0 | 0.2235 | 0.3282 | 0.2243 | 0.0544 |
| | η = 1e⁻⁴, λ = 1e⁻³ | 0.3137 | 0.1961 | 0.0063 | 0.0464 |

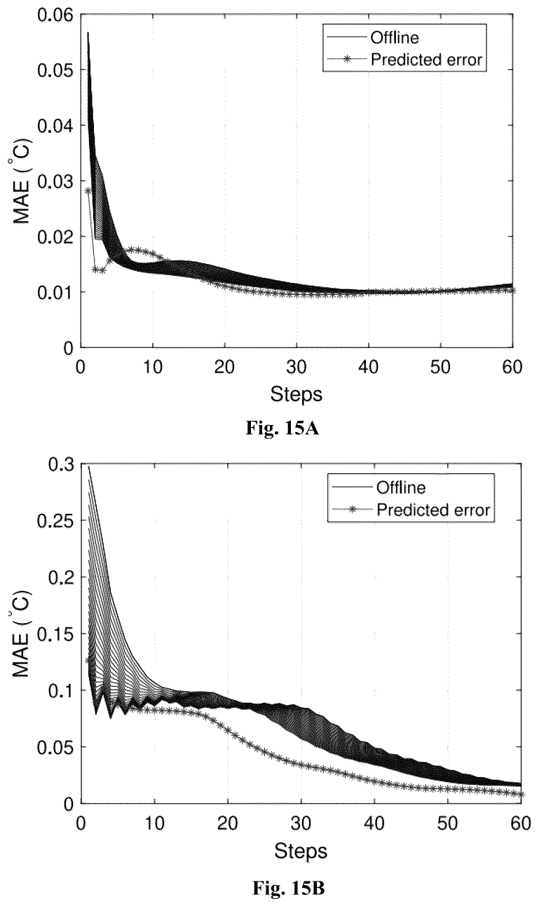

With the optimized PID parameters, the predicted error curve is calculated using the previously described linear regression method according to error samples obtained during the offline mode and this is plotted in FIGS. 15A and 15B. In particular, FIG. 15A illustrates the predicted error curve and plots of the error samples that were obtained during the offline mode for scenario 1 when t=300, Δt=30, s=60, and FIG. 15B illustrates the predicted error curve and plots of the error samples that were obtained during the offline mode for scenario 5 when t=170, Δt=20, s=20. In these plots, there are Δt error samples, whose final time steps range from t−2Δt to t−Δt, each with 60 response steps. The predicted error serves for the prediction at time step t. It is noteworthy that these error values are matrices, and that the illustration of MAE is only for clearer visualization. The error samples MAE gradually decreases with some fluctuations as the response step increases and the MAE are small at the final response step, indicating high prediction accuracy. In this example, a 0.05° C. error is adopted as the acceptable fluctuation range. Thus, the offline MAE of PID error reaches convergence around thirty steps. The predicted error for online mode adjustment is thereafter estimated based on historical offline error data. The predicted error also has 60 response steps, for the prediction at time step t. Other scenarios have similar results. The predicted error can still contain inaccuracy, yet the intrinsic nature of PID compensator can drive the error to zero.

The offline process of hyper-parameter optimization of the neural network is conducted as well as the counterpart to compare with the proposed PID-based accuracy boosting approach. Hyper-parameters in this CNN-LSTM architecture based on the battery surface temperature distribution dataset mainly include the following:
model hyper-parameters: number of filters k for convolutional layers, number of neurons in the fully-connected layers, number of neurons in the LSTM layer, dropout rate of batch normalization layers, and negative slope of the LeakyReLU activation function.
algorithm hyper-parameters: mini-batch size, training epochs, learning rate η, L2 regularization coefficient A, and momentum coefficient in the optimizer.

### Normal Prediction Mode

In the normal prediction of temperature distribution, the PID accuracy boosting algorithm is applied with unknown target values. With the predicted error in offline mode, the update of control signal u is established and propagated along the timeline to provide the prediction result at time t.

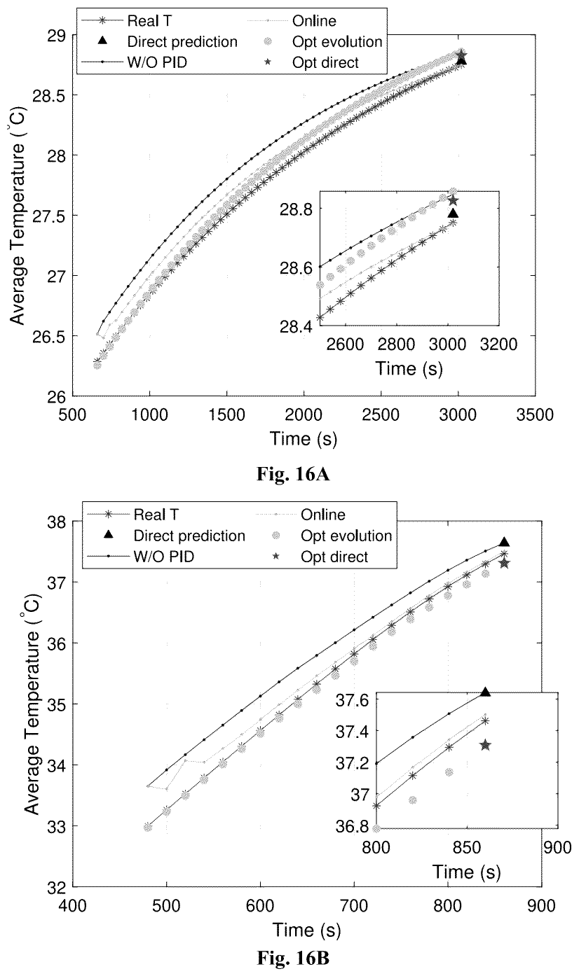

The performance of the PID accuracy boosting algorithm for online prediction is depicted in FIGS. 16A-18D. FIGS. 16A and 16B demonstrate[[s]] the evolution of average temperature with PID steps, and it can be seen that other scenarios have generally similar results. With the PID controller, the temperature evolution tracks the real temperature evolution trace with the effect of predicted error and after the response steps finally achieves better prediction result compared with others. Thus, the integration of the PID compensator is meaningful. The prediction results of the hyper-parameter optimized CNN-LSTM are integrated as well. As depicted, the CNN-LSTM performs well and the PID adjustment can further enhance the performance, which is comparable to the effect of a hyper-parameter optimized network. In particular, FIG. 16A illustrates the predicted average temperature for the various approaches under scenario 1 when t=300, Δt=30, s=60, and FIG. 16B illustrates the predicted average temperature for the various approaches under scenario 5 when t=170, Δt=20,s=20.

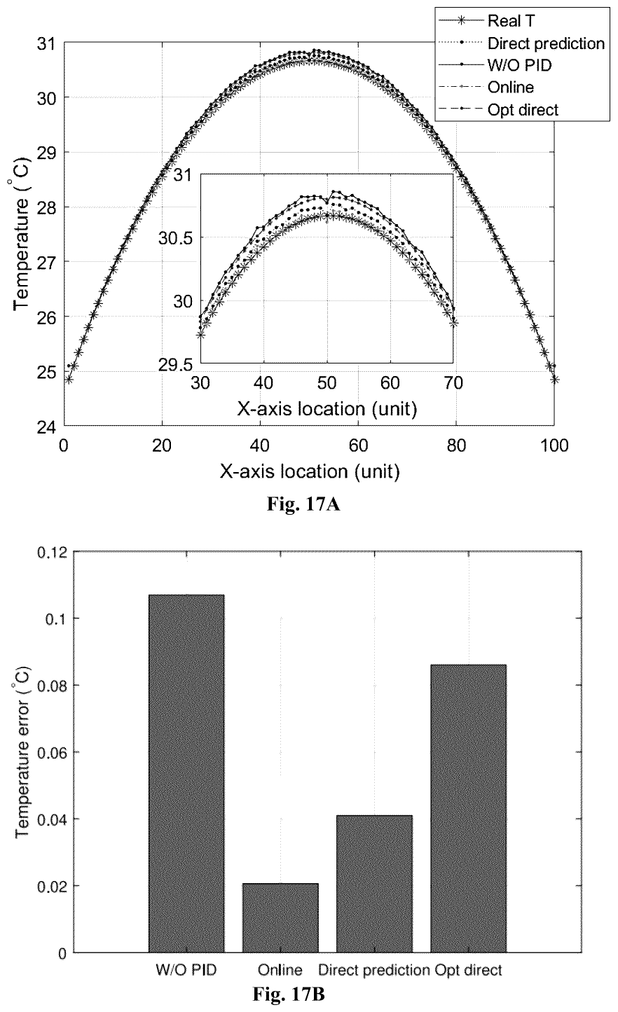

FIGS. 17A and 17B illustrate[[s]] the temperature distribution at time t and the corresponding MAE. Since the PID parameters are set the same for the whole x-axis, in the middle part, some of the temperature points are closer to the real value while some originally with good prediction can diverge from the real value. As shown, on both sides of the distribution, the predicted results are all close to the target. FIG. 17A illustrates the predicted average temperature distribution along the x-axis for the various approaches under scenario 1 when t=300, Δt=30, s=60 and FIG. 17B illustrates the temperature error when the MAE is taken along the x-axis (i.e., under scenario 1). As can be seen, the proposed online prediction result with PID accuracy boosting method has the lowest error. For scenarios 1 and 2, it was found that the online prediction with PID accuracy boosting has the smallest error, proving the effectiveness of PID compensator to reduce prediction error.

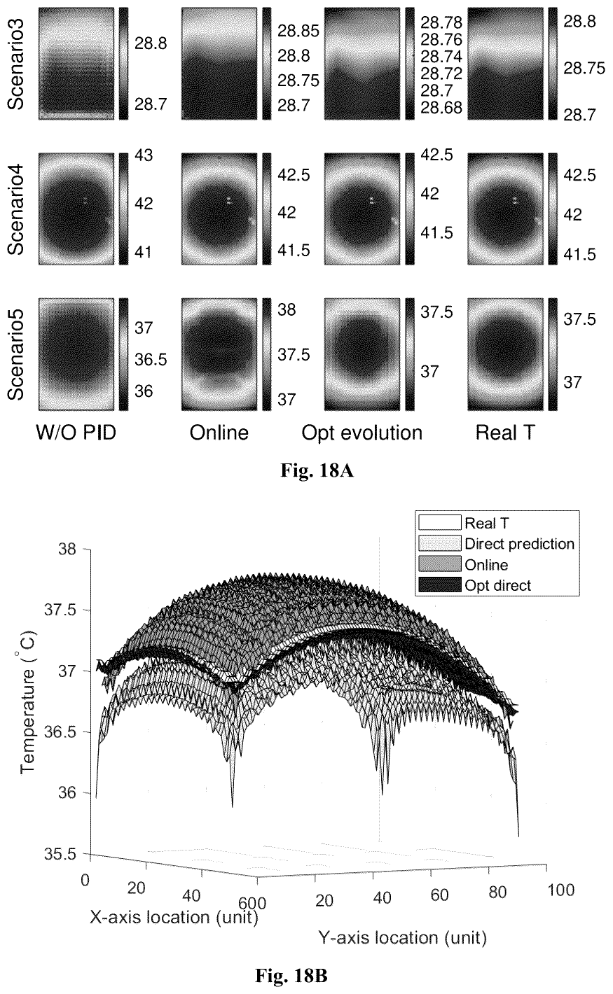

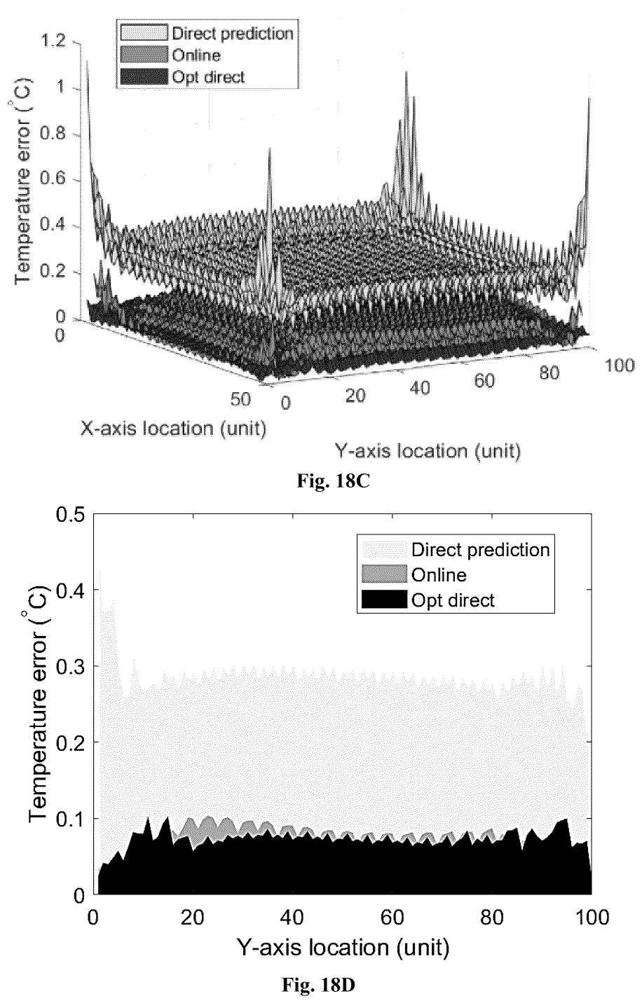

For 2D temperature distribution in scenarios 3, 4 and 5, FIGS. 18A-18D illustrate[[s]] the plane temperature value and the corresponding element-wise absolute error. Based on the basic network, after the PID adjustment, the thermal picture results are illustrated in FIG. 18A at the final time step. For these three scenarios, the PID adjusted results “Online” (i.e., normal operation mode) is comparable to that of the optimized CNN-LSTM “Opt evolution” for future time steps. With the PID accuracy boosting effect, the final prediction has smaller difference to the real distribution compared to others.

In FIG. 18B, the temperature distribution is illustrated for scenario 5 when t=170, Δt=20, s=20, and in FIG. 18C, the temperature error distribution is illustrated for scenario 5 based on the element-wise absolute error. In FIG. 18D the average error is taken over the x-axis for scenario 5. From the comparison of MAE, the prediction performance of hyper-parameter optimized CNNLSTM and PID-based online calculation have both clearly improved. The performance of PID-based accuracy boosting algorithm for the neural network is comparable to that of the hyper-parameter optimized neural network in online calculation mode. In scenario 5, the PID accuracy improvement is the most obvious since the direct prediction performance has a certain gap to the real value. For clearer visualization, the final prediction of “W/O PID” is not shown, the results of which stay above “Online” results and have larger error, providing validation for the PID accuracy boosting algorithm.

Since in the PID accuracy boosting algorithm, the number of error samples Δt, the PID response steps s and the online final prediction time step t are all adjustable parameters, Tables 6 (Table 6a and 6b) and 7 below compares several different combinations of these parameters to provide further online prediction performance analysis.

TABLE 6a

| | | | | Direct prediction MAE | | W/O PID MAE | |
|---|---|---|---|---|---|---|---|
| | | | | (° C.) | | (° C.) | |
| | Δt | s | t | Basic | Opt | Basic | Opt |
| S1 | 20 | 20 | 120 | 0.0232 | 0.0212 | 0.0146 | 0.0210 |
| | 20 | 30 | 200 | 0.0152 | 0.0066 | 0.0094 | 0.0006 |
| | 30 | 60 | 300 | 0.0327 | 0.0290 | 0.1001 | 0.0158 |
| | 20 | 60 | 350 | 0.0344 | 0.0468 | 0.0463 | 0.0321 |
| S2 | 20 | 20 | 120 | 0.0768 | 0.0196 | 0.0463 | 0.0365 |
| | 20 | 30 | 200 | 0.0455 | 0.0190 | 0.0687 | 0.0295 |
| | 30 | 60 | 300 | 0.0505 | 0.0190 | 0.0809 | 0.0575 |
| | 20 | 20 | 350 | 0.1218 | 0.0179 | 0.0560 | 0.0666 |
| S3 | 20 | 20 | 120 | 0.0522 | 0.0150 | 0.0529 | 0.0150 |
| | 30 | 20 | 200 | 0.0388 | 0.0223 | 0.0390 | 0.0223 |
| | 30 | 60 | 300 | 0.0549 | 0.0209 | 0.0549 | 0.0209 |
| | 60 | 30 | 330 | 0.0395 | 0.0236 | 0.0397 | 0.0236 |
| S4 | 20 | 20 | 120 | 0.3708 | 0.1251 | 0.1977 | 0.1252 |
| | 20 | 20 | 200 | 0.3479 | 0.1533 | 0.3479 | 0.1532 |
| | 20 | 60 | 300 | 0.2296 | 0.3039 | 0.2308 | 0.3040 |
| | 20 | 30 | 310 | 0.4744 | 0.2850 | 0.0973 | 0.0801 |
| S5 | 20 | 20 | 120 | 0.0550 | 0.0546 | 0.0550 | 0.0546 |
| | 20 | 20 | 150 | 0.1965 | 0.1162 | 0.1965 | 0.1162 |
| | 20 | 30 | 180 | 0.1270 | 0.1626 | 0.1285 | 0.1626 |
| | 20 | 20 | 190 | 0.5373 | 0.2260 | 0.5373 | 0.2260 |

TABLE 6b

| | |
|---|---|
| OnlineMAR (° C.) | MAE reduction rate (%) |

| | PID | Basic | Opt |
|---|---|---|---|
| S1 | 0.0122 | 16.44 | 8.62 |
| | 0.0102 | −8.51 | 56.58 |
| | 0.0080 | 75.54 | 11.31 |
| | 0.0203 | 40.99 | −2.69 |
| | 0.0361 | 22.03 | 21.17 |
| S2 | 0.0480 | −5.49 | 45.65 |
| | 0.0415 | 17.82 | 28.92 |
| | 0.0383 | 31.61 | −18.93 |
| S3 | 0.0257 | 50.77 | 71.26 |
| | 0.0152 | 60.82 | 42.53 |
| | 0.0167 | 69.58 | 61.93 |
| | 0.0154 | 61.01 | 40.25 |
| S4 | 0.1092 | 44.76 | 36.67 |
| | 0.0579 | 83.36 | 55.94 |
| | 0.0762 | 66.81 | −31.72 |
| | 0.0571 | 34.89 | 17.68 |
| S5 | 0.0913 | −66.0 | 0.73 |
| | 0.0679 | 65.45 | 40.87 |
| | 0.0745 | 41.34 | −26.54 |
| | 0.2108 | 60.77 | 57.94 |

TABLE 7
Online prediction time of test cases compared
with hyper-parameter optimized CNN-LSTM.

| | | | | Calculation | | Calculation time | |
|---|---|---|---|---|---|---|---|
| | | | | time (s) | | reduction rate (%) | |
| | Δt | s | t | PID | Opt | PID | Opt |
| S1 | 20 | 20 | 120 | 0.4196 | 0.4501 | | |
| | 20 | 30 | 200 | 0.3306 | 0.3501 | | |
| | 30 | 60 | 300 | 0.6795 | 0.6301 | | |
| | 20 | 60 | 350 | 0.7001 | 0.5800 | | |
| S2 | 20 | 20 | 120 | 0.4300 | 0.4803 | | |
| | 20 | 30 | 200 | 0.5195 | 0.3606 | | |
| | 30 | 60 | 300 | 0.3605 | 0.3800 | | |
| | 20 | 20 | 350 | 0.4206 | 0.8200 | | |
| S3 | 20 | 20 | 120 | 2.7001 | 3.1702 | 37.05 | 26.09 |
| | 30 | 20 | 200 | 2.8502 | 3.1097 | 33.55 | 27.5 |
| | 30 | 60 | 300 | 2.6302 | 3.2001 | 38.68 | 25.39 |
| | 60 | 30 | 330 | 3.9804 | 4.6865 | 7.2 | −9.27 |
| S4 | 20 | 20 | 120 | 2.9104 | 2.9999 | 32.14 | 30.06 |
| | 20 | 20 | 200 | 2.6704 | 3.0799 | 37.74 | 28.19 |
| | 20 | 60 | 300 | 7.9305 | 8.7706 | −84.9 | −104.49 |
| | 20 | 30 | 310 | 3.9202 | 4.4328 | 8.6 | −3.35 |
| S5 | 20 | 20 | 120 | 2.5602 | 3.6788 | 40.31 | 14.23 |
| | 20 | 20 | 150 | 2.7603 | 3.8404 | 35.64 | 10.46 |
| | 20 | 30 | 180 | 4.1405 | 4.9905 | 3.46 | −16.36 |
| | 20 | 20 | 190 | 2.7500 | 3.4198 | 35.88 | 20.27 |

The hyper-parameter optimized CNN-LSTM is compared with the proposed PID accuracy boosting algorithm in terms of online computation time and online computation error. Meanwhile the calculation time of online prediction is compared with CFD 3D finite element model in ANSYS. The model has 10 divisions on the battery cell edge along the z-axis and the average calculation time is 4.289 s. The calculation time of the online prediction mode to approximate 3D temperature distribution, is assessed with the framework to compute 10 layers of 2D temperature distribution. Thereafter, the estimated online prediction time in different test cases is compared with that of CFD model.

Based on the test cases, a smaller number of samples Δt, and smaller response step s leads to comparatively higher prediction error reduction rate, since longer prediction time scale can result in divergence from the target. Besides, the calculation time is dependent on the PID response steps. Larger response step has longer calculation time. With the adopted dataset used in this experiment, shorter response steps can achieve better prediction accuracy and cost less computation time. From the bold values highlighted in Tables 6 and 7, the average error reduction of the proposed approach compared to prediction with merely CNN-LSTM is 35.52%. And the average reduction rate of calculation time is 18.78%. For the CNN-LSTM with optimized hyper-parameters, the average error reduction compared with the basic network is 30.18%. And the average reduction rate of online calculation time is 14.06%. Therefore, the PID accuracy boosting algorithm for CNN-LSTM demonstrates the performance of prediction error reduction with unknown targets and is computationally efficient. The performance of which is comparable to that of the hyper-parameter optimized neural network in online calculation mode.

The CNN-LSTM-PID framework presented in this experiment is tested with the 2D battery surface temperature distribution dataset. Thanks to the generality of the neural network model and the small difference between the temperature distribution pattern of cell surface and internal layers, the proposed framework can be conveniently expanded to simulate the 3D temperature distribution, for instance, to increase the input size from one surface layer to 10 layers including surface and internal layers or do polynomial approximation for internal temperature distribution. Therefore, the proposed framework can be handily generalized to accommodate other kinds of dataset and demonstrate the PID accuracy boosting effect for other kinds of neural networks.

With the simulation setup, it was found that the average MAE error reduction rate of the CNN-LSTM-PID framework is 35.52%. Compared with the validated CFD 3D finite element model, the estimated prediction calculation time is 18.78% or less. Concerning the performance of the hyper-parameter optimized CNN-LSTM, the average MAE error reduction rate is 30.18% and the online calculation time reduction rate is 14.06%. Thus, the proposed virtual sensor has comparable effectiveness to the hyper-parameter tuning for the neural network model. The improved accuracy and computational efficiency of the virtual sensing framework strengthens the efforts for BESS thermal management and operation security and makes it applicable for real-time management. Future research potential includes more dedicated design of PID compensator, the application of PID accuracy boosting for more kinds of neural networks and extending the CNNLSTM-PID framework to accommodate three-dimensional distribution data.

### Embodiment of the Virtual Sensor

A virtual sensor module for computing spatial-temporal temperature measurements of a battery is disclosed whereby the module comprises a Proportional-Integral-Derivative (PID) controller module communicatively coupled to a trained convolutional neural network—long-short-term memory (CNN-LSTM) module. The PID controller module is configured to trigger the trained CNN-LSTM module to generate refined predicted real temperature sequences across the battery based on a set of optimized PID parameters (K*ₚ, K*ᵢ, K*_{d}), predicted error sequences, and measured temperature sequences of the battery. In this embodiment, the CNN-LSTM module was trained based on a training set of spatial-temporal temperature measurements of the battery, and the optimized PID parameters were generated based on a training set of measured temperature sequences and a series of known output temperature sequences.

According to another aspect of this embodiment, the generation of the optimized PID parameters based on the training set of measured temperature sequences and the series of known output temperature sequences comprises the PID controller module being configured to generate the optimized PID parameters by optimizing PID parameters (Kₚ, Kᵢ, K_{d}) using a Tree-structured Parzen Estimator (TPE) algorithm based on the training set of measured temperature sequences and the series of known output temperature sequences.

According to another aspect of this embodiment, the optimization of the PID parameters (Kₚ, Kᵢ, K_{d}) using the TPE algorithm comprises the PID controller module being configured to obtain the training set of measured temperature sequences and the series of known output temperature sequences; perform a plurality of PID adjustment iterations. Each PID adjustment iteration comprises the steps of: selecting a unique series of measured temperature sequences associated with the PID adjustment iteration from the training set of measured temperature sequences; determining an objective function for the TPE algorithm based on a Mean Absolute Error (MAE) error of a final output temperature of the unique series of measured temperature sequences and a first-order difference of output temperature sequences of the unique series of measured temperature sequences; assigning a set of the PID parameters (Kₚ, Kᵢ, K_{d}) as input for the objective function of the TPE algorithm; computing, using the TPE algorithm, a set of optimal PID parameters (K*ₚₒ, K*ᵢₒ, K*_{do}) for the PID adjustment iteration based on the input set of PID parameters (Kₚ, Kᵢ, K_{d}), and obtaining the optimized PID parameters (K*ₚ, K*ᵢ, K*_{d}) as an average of all the optimal PID parameters (K*ₚₒ, K*ᵢₒ, K*_{do}) of all the PID adjustment iterations.

According to another aspect of this embodiment, each output temperature sequence of the unique series of measured temperature sequences is generated by the trained CNN-LSTM module based on a combination of a control signal sequence associated with a previous output temperature sequence and a current measured temperature sequence from the unique series of measured temperature sequences, whereby the control signal sequence is generated based on the set of optimizable PID parameters (Kₚ, Kᵢ, K_{d}) and a computed error sequence associated with the control signal sequence, whereby the computed error sequence is generated based on a previously known output temperature sequence and the previous output temperature sequence.

According to another aspect of this embodiment, the predicted error sequences are computed using a linear regression model.

According to another aspect of this embodiment, the predicted error sequences are computed using a linear regression model and whereby the computation of the predicted error sequences using the linear regression model comprises the PID controller module being configured to obtain the training set of measured temperature sequences and the series of known output temperature sequences; perform another plurality of PID adjustment iterations for each of the measured temperature sequences in the training set of measured temperature sequences based on the optimized PID parameters (K*ₚ, K*ᵢ, K*_{d}) to obtain a series of error data samples, wherein each error data sample is associated with each PID adjustment iteration; and perform linear regression on the series of error data samples to obtain the predicted error sequences, whereby the linear regression model is defined by a plurality of coefficient matrices associated with a time series of the series of error data samples.

According to another aspect of this embodiment, the training set of spatial-temporal temperature measurements of the battery comprises time series measurements of temperature distribution across the surface of the battery.

According to another aspect of this embodiment, the triggering of the CNN-LSTM module to generate the refined predicted series of real temperature sequences across the battery by the PID controller module comprises the PID controller module being configured to generate control signal sequences based on the set of optimized PID parameters (K*ₚ, K*ᵢ, K*_{d}) and the predicted error sequences; combine the control signal sequences with the associated measured temperature sequences of the battery; and provide the combined control signal sequences with the associated measured temperature sequences of the battery to an input of the CNN-LSTM module to generate the refined predicted series of real temperature sequences across the battery.

According to another aspect of this embodiment, whereby before the PID controller module combines the control signal sequences with the associated measured temperature sequences of the battery, the PID controller module is further configured to regulate, using a limiter module, the control signal sequences.

According to another aspect of this embodiment, the CNN-LSTM module is further configured to use an Adam optimizer to update parameters in the CNN-LSTM module during the training of the CNN-LSTM module.

According to another aspect of this embodiment, the PID controller module is further configured to obtain another set of optimized PID parameters (K*ₚ, K*ᵢ, K*_{d}); obtain another set of predicted error sequences; obtain another measured temperature sequences of the battery; and trigger the CNN-LSTM module to generate another refined predicted series of real temperature sequences across the battery based on the obtained another set of optimized PID parameters (K*ₚ, K*ᵢ, K*_{d}); and the another set of predicted error sequences and the another measured temperature sequences of the battery.

Numerous other changes, substitutions, variations, and modifications may be ascertained by the skilled in the art and it is intended that the present application encompass all such changes, substitutions, variations, and modifications as falling within the scope of the appended claims.

1. A virtual sensor module for computing spatial-temporal temperature measurements of a battery, the module comprising:
a Proportional-Integral-Derivative (PID) controller module communicatively coupled to a trained convolutional neural network—long-short-term memory (CNN-LSTM) module, the PID controller module being configured to:
trigger the trained CNN-LSTM module to generate refined predicted real temperature sequences across the battery based on a set of optimized PID parameters (K*ₚ, K*ᵢ, K*_{d}), predicted error sequences, and measured temperature sequences of the battery,
whereby the CNN-LSTM module was trained based on a training set of spatial-temporal temperature measurements of the battery, and
whereby the optimized PID parameters were generated based on a training set of measured temperature sequences and a series of known output temperature sequences.

2. The virtual sensor module according to claim 1 wherein the generation of the optimized PID parameters based on the training set of measured temperature sequences and the series of known output temperature sequences comprises the PID controller module being configured to:
generate the optimized PID parameters by optimizing PID parameters (Kₚ, Kᵢ, K_{d}) using a Tree-structured Parzen Estimator (TPE) algorithm based on the training set of measured temperature sequences and the series of known output temperature sequences.

3. The virtual sensor module according to claim 2 whereby the optimization of the PID parameters (Kₚ, Kᵢ, K_{d}) using the TPE algorithm comprises the PID controller module being configured to:
obtain the training set of measured temperature sequences and the series of known output temperature sequences;
perform a plurality of PID adjustment iterations, each PID adjustment iteration comprising the steps of:
selecting a unique series of measured temperature sequences associated with the PID adjustment iteration from the training set of measured temperature sequences;
determining an objective function for the TPE algorithm based on a Mean Absolute Error (MAE) error of a final output temperature of the unique series of measured temperature sequences and a first-order difference of output temperature sequences of the unique series of measured temperature sequences;
assigning a set of the PID parameters (Kₚ, Kᵢ, K_{d}) as input for the objective function of the TPE algorithm;
computing, using the TPE algorithm, a set of optimal PID parameters (K*ₚₒ, K*ᵢₒ, K*_{do}) for the PID adjustment iteration based on the input set of PID parameters (Kₚ, Kᵢ, K_{d}), and
obtaining the optimized PID parameters (K*ₚ, K*ᵢ, K*_{d}) as an average of all the optimal PID parameters (K*ₚₒ, K*ᵢₒ, K*_{do}) of all the PID adjustment iterations.

4. The virtual sensor module according to claim 3,
whereby each output temperature sequence of the unique series of measured temperature sequences is generated by the trained CNN-LSTM module based on a combination of a control signal sequence associated with a previous output temperature sequence and a current measured temperature sequence from the unique series of measured temperature sequences,
whereby the control signal sequence is generated based on the set of optimizable PID parameters (Kₚ, Kᵢ, K_{d}) and a computed error sequence associated with the control signal sequence,
whereby the computed error sequence is generated based on a previously known output temperature sequence and the previous output temperature sequence.

5. The virtual sensor module according to claim 1, wherein the predicted error sequences are computed using a linear regression model.

6. The virtual sensor module according to claim 3, wherein the predicted error sequences are computed using a linear regression model and whereby the computation of the predicted error sequences using the linear regression model comprises the PID controller module being configured to:
obtain the training set of measured temperature sequences and the series of known output temperature sequences;
perform another plurality of PID adjustment iterations for each of the measured temperature sequences in the training set of measured temperature sequences based on the optimized PID parameters (K*ₚ, K*ᵢ, K*_{d}) to obtain a series of error data samples, wherein each error data sample is associated with each PID adjustment iteration; and
perform linear regression on the series of error data samples to obtain the predicted error sequences, whereby the linear regression model is defined by a plurality of coefficient matrices associated with a time series of the series of error data samples.

7. The virtual sensor module according to claim 1, wherein the training set of spatial-temporal temperature measurements of the battery comprises time series measurements of temperature distribution across the surface of the battery.

8. The virtual sensor module according to claim 1 whereby the triggering of the CNN-LSTM module to generate the refined predicted series of real temperature sequences across the battery by the PID controller module comprises the PID controller module being configured to:
generate control signal sequences based on the set of optimized PID parameters (K*ₚ, K*ᵢ, K*_{d}) and the predicted error sequences;
combine the control signal sequences with the associated measured temperature sequences of the battery; and
provide the combined control signal sequences with the associated measured temperature sequences of the battery to an input of the CNN-LSTM module to generate the refined predicted series of real temperature sequences across the battery.

9. The virtual sensor module according to claim 8 whereby before the PID controller module combines the control signal sequences with the associated measured temperature sequences of the battery, the PID controller module is further configured to:
regulate, using a limiter module, the control signal sequences.

10. The virtual sensor module according to claim 1 whereby the CNN-LSTM module is further configured to use an Adam optimizer to update parameters in the CNN-LSTM module during the training of the CNN-LSTM module.

11. The virtual sensor module according to claim 1, whereby the PID controller module is further configured to:
obtain another set of optimized PID parameters (K*ₚ, K*ᵢ, K*_{d});
obtain another set of predicted error sequences;
obtain another measured temperature sequences of the battery; and
trigger the CNN-LSTM module to generate another refined predicted series of real temperature sequences across the battery based on the obtained another set of optimized PID parameters (K*ₚ, K*ᵢ, K*_{d}); the another set of predicted error sequences and the another measured temperature sequences of the battery.

12. A method for computing spatial-temporal temperature measurements of a battery using a virtual sensor module, the method comprising:
triggering, using a Proportional-Integral-Derivative (PID) controller module communicatively coupled to a trained convolutional neural network—long-short-term memory (CNN-LSTM) module, the trained CNN-LSTM module to generate refined predicted series of real temperature sequences across the battery based on a set of optimized PID parameters (K*ₚ, K*ᵢ, K*_{d}), predicted error sequences, and a series of measured temperature sequences of the battery,
whereby the CNN-LSTM module was trained based on a training set of spatial-temporal temperature measurements of the battery, and
whereby the optimized PID parameters were generated based on a training set of measured temperature sequences and a series of known output temperature sequences.

13. The method according to claim 12 wherein the generation of the optimized PID parameters based on the training set of measured temperature sequences and the series of known output temperature sequences comprises the steps of:
generating the optimized PID parameters by optimizing PID parameters (Kₚ, Kᵢ, K_{d}) using a Tree-structured Parzen Estimator (TPE) algorithm based on the training set of measured temperature sequences and the series of known output temperature sequences.

14. The method according to claim 13 whereby the optimization of the PID parameters (Kₚ, Kᵢ, K_{d}) using the TPE algorithm comprises:
obtaining the training set of measured temperature sequences and the series of known output temperature sequences;
performing a plurality of PID adjustment iterations, each PID adjustment iteration comprising the steps of:
selecting a unique series of measured temperature sequences associated with the PID adjustment iteration from the training set of measured temperature sequences;
determining an objective function for the TPE algorithm based on a Mean Absolute Error (MAE) error of a final output temperature of the unique series of measured temperature sequences and a first-order difference of output temperature sequences of the unique series of measured temperature sequences;
assigning a set of the PID parameters (Kₚ, Kᵢ, K_{d}) as input for the objective function of the TPE algorithm;
computing, using the TPE algorithm, a set of optimal PID parameters (K*ₚₒ, K*ᵢₒ, K*_{do}) for the PID adjustment iteration based on the input set of PID parameters (Kₚ, Kᵢ, K_{d}), and
obtaining the optimized PID parameters (K*ₚ, K*ᵢ, K*_{d}) as an average of all the optimal PID parameters (K*ₚₒ, K*ᵢₒ, K*_{do}) of all the PID adjustment iterations.

15. The method according to claim 14 whereby each output temperature sequence of the unique series of measured temperature sequences is generated by the trained CNN-LSTM module based on a combination of a control signal sequence associated with a previous output temperature sequence and a current measured temperature sequence from the unique series of measured temperature sequences,
whereby the control signal is generated based on the set of optimizable PID parameters (Kₚ, Kᵢ, K_{d}) and a computed error sequence associated with the control signal sequence,
whereby the computed error sequence is generated based on a previously known output temperature sequence and the previous output temperature sequence.

16. The method according to claim 12, wherein the predicted error sequences are computed using a linear regression model.

17. The method according to claim 14, wherein the predicted error sequences are computed using a linear regression model and whereby the computation of the predicted error sequences using the linear regression model comprises the steps of:
obtaining the training set of measured temperature sequences and the series of known output temperature sequences;
performing another plurality of PID adjustment iterations for each of the measured temperature sequences in the training set of measured temperature sequences based on the optimized PID parameters (K*ₚ, K*ᵢ, K*_{d}) to obtain a series of error data samples, wherein each error data sample is associated with each PID adjustment iteration; and
performing linear regression on the series of error data samples to obtain the predicted error sequences, whereby the linear regression model is defined by a plurality of coefficient matrices associated with a time series of the series of error data samples.

18. The method according to claim 12, wherein the training set of spatial-temporal temperature measurements of the battery comprises time series measurements of temperature distribution across the surface of the battery.

19. The method according to claim 12, whereby the triggering of the CNN-LSTM module to generate the refined predicted series of real temperature sequences across the battery by the PID controller module comprises the steps of:
generating control signal sequences based on the set of optimized PID parameters (K*ₚ, K*ᵢ, K*_{d}) and the predicted error sequences;
combining the control signal sequences with the associated measured temperature sequences of the battery; and
providing the combined control signal sequences with the associated measured temperature sequences of the battery to an input of the CNN-LSTM module to generate the refined predicted series of real temperature sequences across the battery.

20. The method according to claim 19 whereby before the PID controller module combines the control signal sequences with the associated measured temperature sequences of the battery, the method further comprises the step of:
regulating, using a limiter module, the control signal sequences.
